(19) United States
(12) Patent Application Publication
(10) Pub. No.: US 2025/0267174 A1
(43) Pub. Date: Aug. 21, 2025

(54) INFORMATION PROCESSING APPARATUS AND CONTROL METHOD

(71) Applicant: CANON KABUSHIKI KAISHA, Tokyo (JP)

(72) Inventor: TAKAHIRO MURATA, Kanagawa (JP)

(21) Appl. No.: 19/056,483

(22) Filed: Feb. 18, 2025

(30) Foreign Application Priority Data
Feb. 19, 2024 (JP) 2024-023236

(51) Int. Cl. H04L 9/40

(52) U.S. Cl. CPC H04L 63/20

(57) ABSTRACT

An image processing apparatus performs control in such a manner that first processing for storing at least a part of a setting value group receives as a target for import as an operation setting which is retained in a non-volatile random access memory (NVRAM) and second processing for, after the first processing, storing, by overwrite, setting values of a setting item in such a way as to satisfy a security policy, as a part of the operation setting which is retained in the NVRAM are performed as a series of processing operations in import processing.

### BACKGROUND

### Field of the Disclosure

Aspects of the present disclosure generally relate to a technique for importing a setting value of an information processing apparatus.

### Description of the Related Art

Personal computers (PCs) or server equipment which connects to networks located in, for example, offices are desirable to be operated according to security policies defined by the respective offices. The security policy is a fundamental policy concerning the information security of the whole enterprise, which is obtained by compiling policies for preventing the abuse of information, external intrusion, and information leak.

The equipment which connects to networks located in offices includes, in addition to PCs and server equipment, image processing apparatuses such as multifunction peripherals and printers. Each of recent image processing apparatuses not only simply prints or transmits images but also provides, to the user, a web user interface (UI) which enables the user to operate the image processing apparatus via a web browser present on a PC or provides, to the user, various cloud services cooperating with respective cloud servers. Thus, image processing apparatuses have come to play a role similar to that of another PC or server equipment present on a network. Accordingly, to maintain a safe and secure office environment, as with PCs and server equipment, even in image processing apparatuses, the user is required to follow a security policy.

Here, following a security policy means, for example, imposing a limitation on an operation regarding security on the image processing apparatus so as to prevent abuse or information leak, such as making user authentication mandatory or making encryption in a communication pathway mandatory.

In such an image processing apparatus, control for maintaining a state following a security policy is performed. Specifically, when a given security policy has been set, a setting item related to the set security policy becomes a fixed value, so that the setting item becomes unable to be changed by any user other than a security administrator.

Moreover, each of recent image processing apparatuses has various functions and thus has a large number of setting items to cause such various functions to appropriately operate. There is equipment which has the function of compiling such setting items, exporting the compiled setting items as a file format to outside the equipment, and, after that, importing the setting items at a certain opportunity (hereinafter referred to as a “setting value import function”).

Furthermore, examples of the above-mentioned certain opportunity include, first, an opportunity at which, in an enterprise, due to the influence of an external environment accompanied by departmental arrangement or personnel relocating, setting items of, for example, a network, an address book, and a security policy are applied in a simplified procedure. Alternatively, examples of the above-mentioned certain opportunity also include a case where the backup of a setting value is performed immediately before initialization at the time of delivery to, for example, a manufacturer service for, for example, repair and the setting value is restored after the repair is complete. Then, at various opportunities or scenes such as situations of the installation including the relocation of a device in an enterprise or home in a subscription service, which has recently begun to gain popularity, or settings inheritance at the time of replacement or settings application in an intrinsic environment, the restoration of a setting group from an existing state or the measures of a convenience improvement by a setting group batch conversion matching an environment are being requested.

At this time, to maintain a state following a security policy, with regard to a specific setting value on which a limitation is imposed by the security policy, it is necessary to perform a setting value initialization function in such a way as not to deviate from the security policy.

Japanese Patent Application Laid-Open No. 2015-180990 discusses a technique which checks whether a security policy is individually satisfied with respect to each of a large number of setting items included in an image processing apparatus and imports only the setting items which satisfy the security policy.

In the case of a configuration which, as mentioned above, checks whether a security policy is individually satisfied with respect to each setting item to determine whether to import the setting item, a processing load for determination increases in proportion to the number of setting items and an increase of the number of security policy items. As a result, the processing time for the setting value import function increases, so that the user's waiting time may become longer. Particularly, with regard to an image processing apparatus of the low-end model with a relatively low central processing unit (CPU) capability, such an influence becomes conspicuous.

### SUMMARY

According to an aspect of the present disclosure, an information processing apparatus includes a non-volatile memory, a first management unit configured to manage a security policy setting, a second management unit configured to manage setting values of a setting item group which affects at least one or more operations of the information processing apparatus, one or more memories storing instructions, and one or more processors capable of executing the instructions causing the information processing apparatus to retain, in the non-volatile memory, an operation setting of the information processing apparatus, receive a setting value group serving as a target for import, and perform control in such a manner that first processing for storing at least a part of the received setting value group as the operation setting which is retained in the non-volatile memory and second processing for, after the first processing, storing, by overwrite, setting values which the second management unit manages in such a way as to satisfy the security policy setting which the first management unit manages, as a part of the operation setting which is retained in the non-volatile memory are performed as a series of processing operations in import processing.

Further features of the present disclosure will become apparent from the following description of exemplary embodiments with reference to the attached drawings.

### BRIEF DESCRIPTION OF THE DRAWINGS

FIG. 1 is a diagram illustrating an example of a network configuration in an exemplary embodiment of the present disclosure.

FIG. 2 is an appearance diagram of an image processing apparatus serving as an example of an information processing apparatus in the present exemplary embodiment.

FIG. 3 is a diagram illustrating an example of a hardware configuration of the image processing apparatus.

FIG. 4 is a diagram used to explain an operation display unit of the image processing apparatus.

FIG. 5 is a diagram used to explain a software configuration of the image processing apparatus.

FIGS. 6A and 6B are diagrams illustrating setting item management information for the image processing apparatus.

FIG. 7 is a diagram illustrating a dependency relationship between a security policy setting and other settings in the image processing apparatus.

FIGS. 8A, 8B, 8C, and 8D are diagrams illustrating display examples of screens each of which is displayed by a terminal device at the time of setting of a security policy.

FIG. 9 is a flowchart illustrating security policy setting processing.

FIG. 10 is a diagram illustrating examples of setting screens for setting items the setting change of which is limited by the security policy.

FIGS. 11A, 11B, 11C, and 11D are diagrams illustrating examples of setting screens each of which is displayed at the time of performing a setting value export function in the image processing apparatus.

FIGS. 12A and 12B are flowcharts illustrating setting value export processing in the image processing apparatus.

FIGS. 13A, 13B, 13C, 13D, and 13E are diagrams illustrating examples of setting screens each of which is displayed at the time of performing a setting value import function in the image processing apparatus.

FIGS. 14A and 14B are flowcharts illustrating setting value import processing in the image processing apparatus.

### DESCRIPTION OF THE EMBODIMENTS

Various exemplary embodiments, features, and aspects of the disclosure will be described in detail below with reference to the drawings. Moreover, with regard to the present disclosure, it should be understood that embodiments obtained by appropriately making alternations or improvements to the exemplary embodiments described below based on the ordinary knowledge of one skilled in the art within the range not departing from the gist of the present disclosure also fall within the scope of the present disclosure.

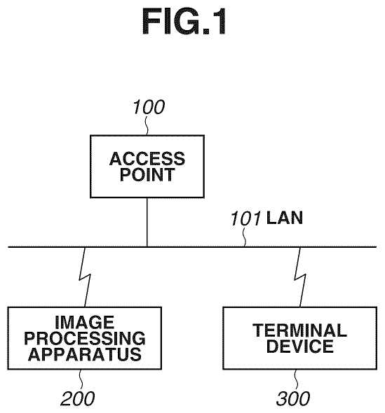

First, a network configuration in an exemplary embodiment of the present disclosure is described with reference to FIG. 1. Furthermore, the network configuration described as follows is merely an example in the present exemplary embodiment, can be applied to various types of configurations capable of performing communications by wired or by wireless between an image processing apparatus and a terminal device, and is not intended to be restricted to the configuration illustrated in FIG. 1. Moreover, in the present specification and the accompanying drawings, a “network” may be referred to as “NW” for abbreviation.

FIG. 1 is a diagram illustrating an example of a network configuration in an exemplary embodiment of the present disclosure.

In the example illustrated in FIG. 1, the network configuration in the present exemplary embodiment includes an access point 100, a local area network (LAN) 101, which the access point 100 forms, and an image processing apparatus 200 and a terminal device 300, which are connected to such a network (LAN 101). Here, the connection form of the LAN 101 can be wired communication or wireless communication, and is assumed to be implemented by a connection using, for example, Wi-Fi® (Wireless Fidelity), which is a communication standard compliant with the IEEE 802.11 series.

In the LAN 101, respective different Internet Protocol (IP) addresses are allocated to the image processing apparatus 200 and the terminal device 300 by the access point 100. This enables designating IP addresses as destinations between devices included in the LAN 101 and causing the devices to perform communications with each other.

The image processing apparatus 200 is an example of an information processing apparatus according to aspects of the present disclosure. The image processing apparatus 200 is, for example, an inkjet printer and provides functions such as print, scan, and facsimile (FAX) to the user. Additionally, the image processing apparatus 200 has a web server function and is capable of performing request reception and response transmission using the HyperText Transfer Protocol (HTTP) function. Furthermore, the functions which are mounted in the image processing apparatus 200 do not need to be restricted to such functions, and some of the above-mentioned functions do not need to be mounted or a function other than the above-mentioned functions can be mounted. Moreover, the image processing apparatus 200 is not restricted to an inkjet printer, but can be another type of apparatus such as a laser beam printer or an office multifunction peripheral. Moreover, the present disclosure is not restricted to an image processing apparatus, but can be applied to various types of information processing apparatuses such as network home electrical appliance and other electronic equipment.

The terminal device 300 is, for example, a smartphone, and provides a web browser function within the device itself to the user. In the web browser function, the terminal device 300 performs request transmission and response reception using the HTTP communication, and performs screen displaying associated with these communications. Furthermore, the functions which are mounted in the terminal device 300 do not need to be restricted to these, and a function other than the above-mentioned functions can be mounted therein.

Moreover, the terminal device 300 is not restricted to a smartphone, but can be another type of device such as a personal computer (PC) or a tablet terminal.

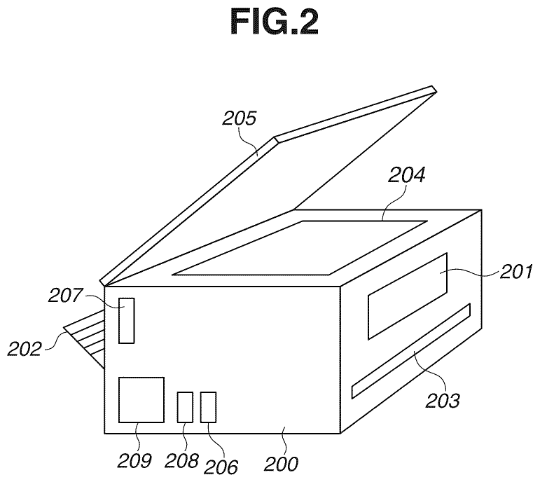

FIG. 2 is a diagram illustrating an example of an appearance of the image processing apparatus 200.

In the present exemplary embodiment, an inkjet printer is illustrated as an example of an image processing apparatus, and this is a multifunction printer (MFP) having print, scan, facsimile (FAX), and other functions in combination.

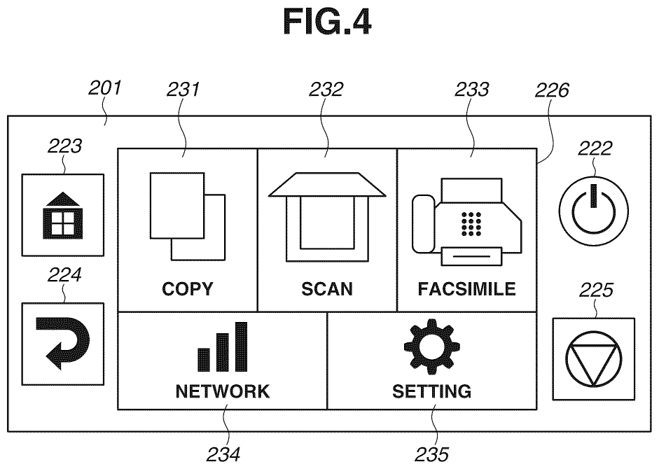

An operation display unit 201 includes a display and buttons which are used to operate the image processing apparatus 200. The details of the operation display unit 201 are described below with reference to FIG. 4.

A printing paper insertion port 202 is an insertion port to which to set sheets of paper with various sizes. The sheets of paper set to the printing paper insertion port 202 are conveyed one by one to a printing unit, are subjected to desired printing, and are discharged from a printing paper discharge port 203.

A document positioning plate 204 is a glasslike transparent plate, on which to put a document and which is used to read the document by a scanner. A document positioning plate pressing plate 205 is a cover which, at the time of reading being performed by the scanner, presses a document against the document positioning plate 204 in such a way as to cause the document not to float and prevents external light from entering a scanning portion.

A Universal Serial Bus (USB) communication unit 206 includes a circuit and a USB connector which are used for the image processing apparatus 200 to perform communications using USB connection with, for example, an external terminal device 300.

A wireless LAN communication unit 207 includes, built therein, circuits such as an antenna, which are used to perform wireless communication using the above-mentioned wireless connection or a direct connection, in which the image processing apparatus 200 itself serves as an access point and forms a wireless LAN.

A facsimile (FAX) communication unit 208 includes circuits which are used to perform FAX transmission and reception and a connector for a telephone cable.

A power source unit 209 includes a power source circuit and a power source jack which are used to supply electric power to the image processing apparatus 200.

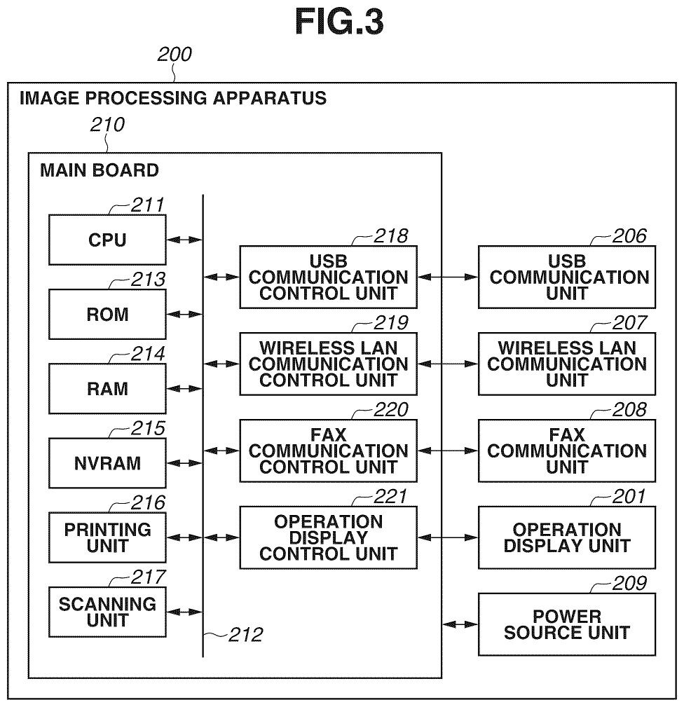

FIG. 3 is a block diagram illustrating an example of a hardware configuration of the image processing apparatus 200.

The image processing apparatus 200 includes a main board 210, which performs control of the entire image processing apparatus 200, the operation display unit 201, the USB communication unit 206, the wireless LAN communication unit 207, the FAX communication unit 208, and the power source unit 209.

A central processing unit (CPU) 211, which is in the form of a microprocessor arranged in the main board 210, operates according to a control program stored in a read-only memory (ROM) 213, to which the CPU 211 is connected via an internal bus 212, and data stored in a random access memory (RAM) 214, to which the CPU 211 is also connected via the internal bus 212. Moreover, various types of operation settings of the image processing apparatus 200 are retained in a non-volatile random access memory (NVRAM) 215, which is a non-volatile memory, and are read and written according to the control program.

The CPU 211 can control a scanning unit 217 to read an image of a document and stores the read image in an image memory, which is a part of the RAM 214. Moreover, the CPU 211 can control a printing unit 216 to print an image retained in the image memory, which is a part of the RAM 214, on a recording medium.

The CPU 211 controls the USB communication unit 206 via a USB communication control unit 218 to perform USB communication using USB connection with an external device. Moreover, the CPU 211 controls the wireless LAN communication unit 207 via a wireless LAN communication control unit 219 to perform wireless LAN communication using infrastructure connection or direct connection with an external device. Additionally, the CPU 211 controls the FAX communication unit 208 via a FAX communication control unit 220 to perform FAX communication using a telephone line with an external device.

The CPU 211 controls an operation display control unit 221 to receive operation information output from the operation display unit 201. Moreover, the CPU 211 can control the operation display control unit 221 to perform displaying of the state of the image processing apparatus 200 or displaying of a function selection menu on the operation display unit 201.

FIG. 4 is a diagram schematically illustrating an example of a configuration of the operation display unit 201 of the image processing apparatus 200. The operation display unit 201 is configured with, for example, a plurality of buttons, a display, and light-emitting diodes (LEDs).

In the example illustrated in FIG. 4, a case where a touch panel liquid crystal display (hereinafter referred to as a “touch display”) is employed as the display of the operation display unit 201 is illustrated. In a state in which electric power is being supplied from the power source unit 209, in response to a power button 222 being pressed by the user, the image processing apparatus 200 starts. In response to the image processing apparatus 200 starting, a home screen (a home screen such as that illustrated in FIG. 4), which is the uppermost layer of a menu which the user is able to operate, is displayed on the touch display 226.

The home screen includes a copy region 231 for receiving an execution instruction for a copy function, a scan region 232 for receiving an execution instruction for a scan function, and a FAX region 233 for receiving an execution instruction for a FAX function. Moreover, the home screen also includes a network region 234 for transitioning to a menu for performing a network setting change or condition confirmation of infrastructure connection or direct connection of the image processing apparatus 200. Additionally, the home screen also includes a setting region 235 for transitioning to a menu for performing, for example, other various setting changes, update of firmware, and a maintenance function such as cleaning.

In a case where inputting of a character string from the user is required for password authentication, a software keyboard can be displayed on the touch display 226 to receive such inputting.

In response to a home button 223 being pressed in a state in which a screen in another menu layer other than the home screen is being displayed, the displayed screen can return to the home screen. Moreover, in response to a back button 224 being pressed in a state in which a screen in another menu layer other than the home screen is being displayed, the displayed screen can return to a screen in a menu layer upper by one layer.

At any timing when each of the various functions such as the copy function and the scan function is being performed and processing is able to be stopped, in response to a stop button 225 being pressed, processing which is being performed can be stopped.

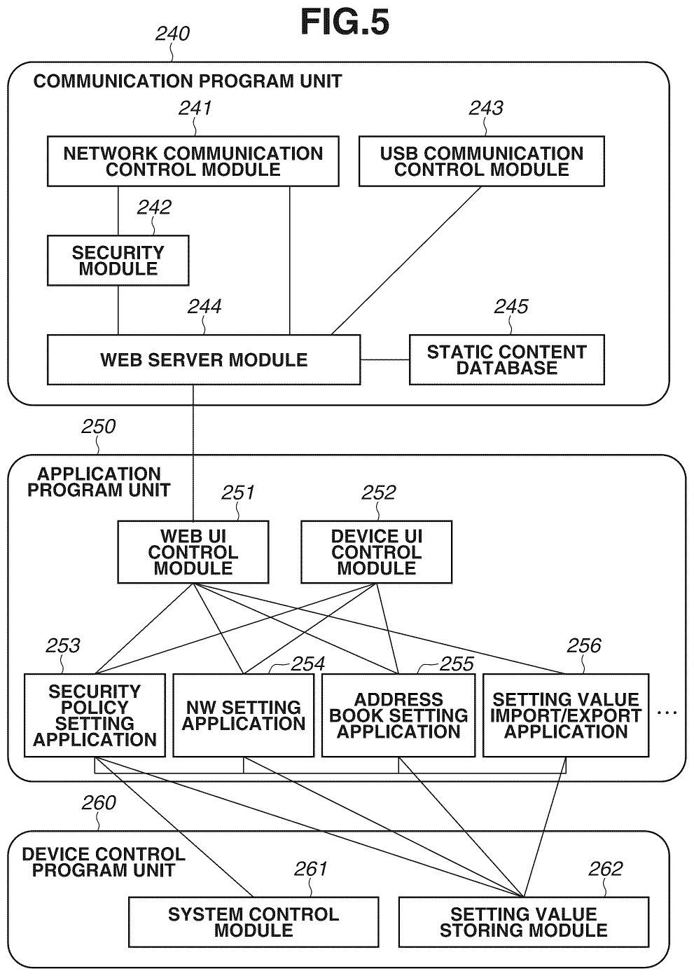

FIG. 5 is a block diagram conceptually illustrating an example of a software configuration for implementing a setting change and a setting value import function out of pieces of software which run in the image processing apparatus 200. Furthermore, processing which is performed for the setting value import function is referred to as “setting import processing” or is referred to simply as “import processing”. Moreover, elements or components of the software illustrated in FIG. 5 are merely examples, and are not intended to restrict the elements or components to those illustrated in FIG. 5.

A software group schematically illustrated in FIG. 5 implements various functions in the image processing apparatus 200 by the CPU 211 executing a control program stored in the ROM 213 with use of a part of data associated with the control program and stored in the RAM 214. The software group includes a communication program unit 240, which mainly performs communication control, an application program unit 250, which mainly controls an application function, and a device control program unit 260, which mainly controls lower layers in the image processing apparatus 200.

The communication program unit 240 includes a network communication control module 241, a security module 242, a USB communication control module 243, a web server module 244, and a static content database 245.

The network communication control module 241 is a module which controls the wireless LAN communication control unit 219 and takes charge of up to the transport layer of communication protocol stack, and implements Transmission Control Protocol/Internet Protocol (TCP/IP) communication for the image processing apparatus 200.

The security module 242 is a module which takes charge of processing for, for example, encryption and decryption of communication and authentication and hash accompanied by such processing, and implements Transport Layer Security/Secure Sockets Layer (TLS/SSL) communication for the image processing apparatus 200.

The USB communication control module 243 is a module which controls the USB communication control unit 218 and takes charge of an operation for the image processing apparatus 200 behaving as a USB device, and implements USB communication for the image processing apparatus 200.

The web server module 244 is a module which takes charge of an operation for the image processing apparatus 200 behaving as a web server, and implements HyperText Transfer Protocol (HTTP) communication with the external terminal device 300 in which a web browser operates. Specifically, the web server module 244 analyzes an HTTP request received from the external terminal device 300, causes a web UI control module 251 or the static content database 245 to operate according to a result of the analysis, and forms and transmits the generated data as an HTTP response. The web server module 244 performs request reception and response transmission with use of TCP/IP communication, TLS/SSL communication, or USB communication.

The static content database 245 is a module which operates as a file system, and performs reading-out of data, such as Joint Photographic Experts Group (JPEG) data or HyperText Markup Language (HTML) data, stored in the ROM 213 or the RAM 214.

The application program unit 250 includes the web UI control module 251, a device UI control module 252, and application modules 253 to 256 taken as examples.

The web UI control module 251 performs data generation for displaying a web UI of the image processing apparatus 200 on the web browser of the external terminal device 300 according to a request from the web server module 244. The web UI control module 251 is able to cause the operational state or setting state of the image processing apparatus 200 to be displayed on the web UI by acquiring the operational state or setting state of the image processing apparatus 200 from the respective application modules and transmitting the shaped data as a response. Moreover, the web UI displayed by the web browser of the terminal device 300 is configured to be able to issue an instruction to perform, for example, a setting change or password authentication for the image processing apparatus 200. When the web browser is operated by the user and an instruction for performing, for example, a setting change or password authentication for the image processing apparatus 200 is issued from the web UI, an HTTP request with the content of the instruction stored therein is received by the image processing apparatus 200. The web UI control module 251 receives such an instruction via the web server module 244 and causes the application module associated with the content of the instruction to perform processing for, for example, the setting change or password authentication. Upon completion of the processing, the web UI control module 251 stores a processing result indicative of success or failure in an HTTP response and transmits the HTTP response via the web server module 244.

The device UI control module 252 implements a UI in the main body of the image processing apparatus 200 by controlling the operation display control unit 221. The device UI control module 252 stores menu layer information and causes, for example, an operation menu corresponding to the current menu layer to be displayed on the touch display 226. Moreover, the device UI control module 252 is also able to acquire the operational state or setting state of the image processing apparatus 200 from the respective application modules, shape the acquired data, and causes the shaped data to be displayed on the touch display 226. Additionally, the device UI control module 252 receives an operation for, for example, a setting change or password authentication from the operation display unit 201 and causes the application module associated with the operation to perform processing therefor. Upon completion of the processing, the device UI control module 252 causes a processing result indicative of success or failure to be displayed on the touch display 226.

The security policy setting application 253 receives an instruction issued from the web UI control module 251 or the device UI control module 252 and performs acquisition of a security policy setting state or changing of a security policy setting.

The NW setting application 254 receives an instruction issued from the web UI control module 251 or the device UI control module 252 and performs acquisition of an NW setting state or changing of an NW setting.

The address book setting application 255 receives an instruction issued from the web UI control module 251 or the device UI control module 252 and performs acquisition of address book information (address setting data constituting an address book) including, for example, FAX destination information and, for example, addition or deletion of new destination information to or from the address book information.

The setting value import/export application 256 receives an instruction issued from the web UI control module 251 and performs import and export processing for setting values of the image processing apparatus 200, a security policy, and an address book. In the present exemplary embodiment, the setting value import/export application 256 is described as respective different names such as a setting value import application 256a and a setting value export application 256b. Furthermore, in the present exemplary embodiment, an operation for performing import and export of setting values is assumed to be performed only via a web UI. This is because export processing which is processing for outputting setting values as an electronic file to an external unit and import processing which is processing for receiving the electronic file as an input are required to be respectively performed as download and upload by a web browser.

The device control program unit 260 includes a system control module 261 and a setting value storing module 262.

The system control module 261 takes charge of such an operation as to comprehensively control the entire software system, such as starting and stopping of the image processing apparatus 200. In the present exemplary embodiment, the system control module 261 receives a restart request from the security policy setting application 253 and thus performs restart processing for the image processing apparatus 200.

The setting value storing module 262 operates in such a way as to comprehensively control, for example, storing of setting values of the image processing apparatus 200, receives an instruction for storing of setting values from another module such as each application module, and performs writing of the setting values to the NVRAM 215. Moreover, the setting value storing module 262 receives an instruction for referring to setting values from another module such as each application module, and performs reading-out of setting values from the NVRAM 215.

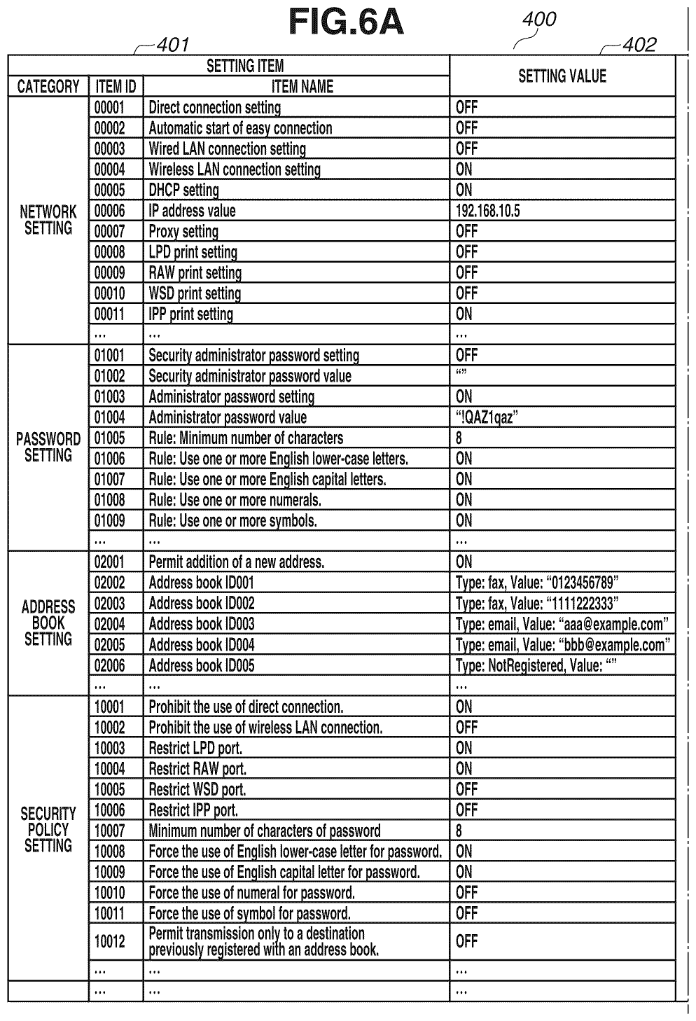

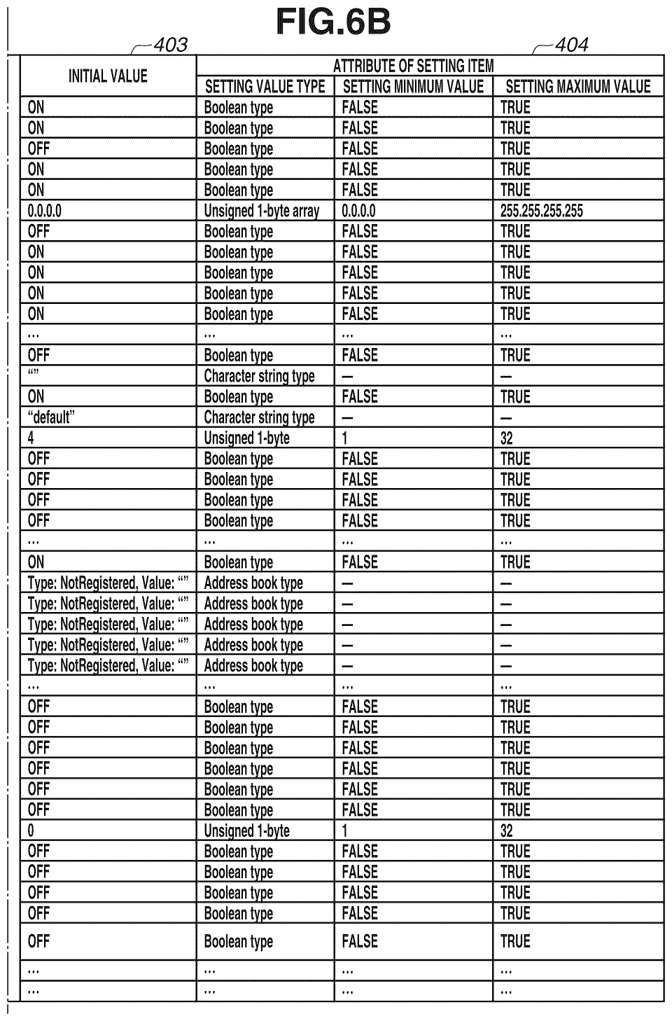

FIGS. 6A and 6B are diagrams schematically illustrating an example of setting item management information for an image processing apparatus in the present exemplary embodiment.

FIGS. 6A and 6B schematically illustrate a part of setting item management information 400 obtained by compiling setting values of the respective setting items and management information therefor retained in the NVRAM 215 via the setting value storing module 262.

As shown in column 401, all of the setting items are able to be uniquely identified by the respective item identifiers (IDs), so that designating an item ID enables performing writing or reading-out of a setting value corresponding to the designated item ID.

Column 402 shows current setting values of the respective setting items.

Column 403 shows factory-configured setting values of the respective setting items. When a setting reset function included in the main the main body setting items is performed, the respective setting items targeted for the setting reset function are set to initial values, which are factory-configured values, shown in column 403.

Column 404 shows attributes of the respective setting items. Each of attributes of the respective setting items is composed of the following three elements, i.e., a setting value type (data type) for retaining each setting value, a minimum value of each setting value (a setting minimum value), and a maximum value of each setting value (a setting maximum value). In the attributes of the respective setting items, the setting value type is not only referred to at the time of internal memory acquisition in exporting a setting value but also used as information constituting a data type in tags to be output. Moreover, the setting minimum value and the setting maximum value in the attributes of the respective setting items are values which are referred to for determining the consistency of a setting value in importing the setting value.

While, in the example illustrated in FIGS. 6A and 6B, the setting item management information 400 is shown in tabular form, the form for use in retaining such information in the image processing apparatus 200 is not limited to this. For example, the setting item management information 400 can be retained in specific database form, or can be retained in another form such as JavaScript Object Notation (JSON) form. Additionally, only the setting values shown in column 402 can be retained in the RAM 214 or the NVRAM 215, and the other pieces of information can be expressed as a program which has been stored in the ROM 213 or table data which has been statically defined.

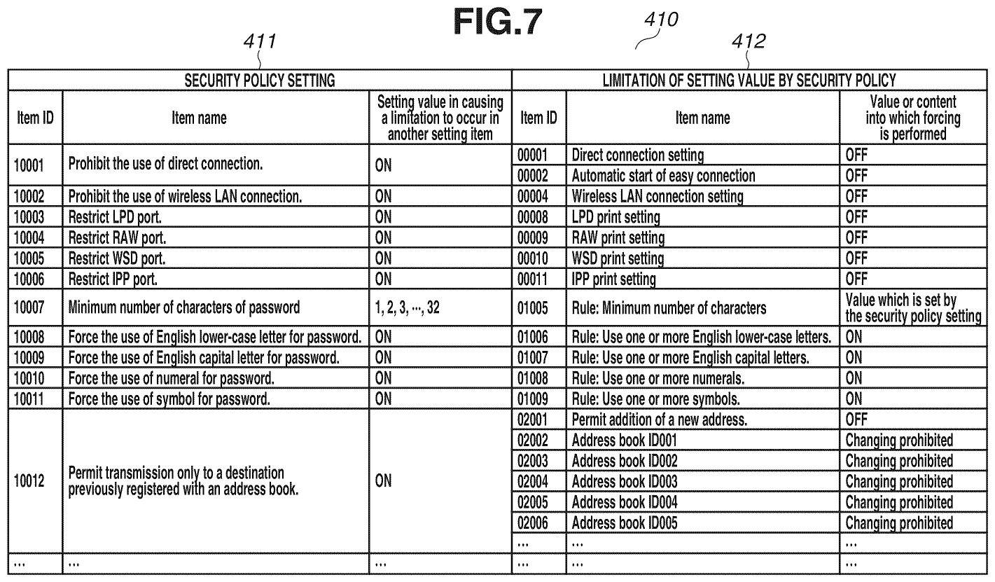

FIG. 7 is a diagram schematically illustrating a dependency relationship between a security policy setting and other settings in the image processing apparatus in the present exemplary embodiment.

FIG. 7 schematically illustrates a part of a dependency relationship 410 between a security policy setting and other settings, which is managed and controlled by the security policy setting application 253. The dependency relationship mentioned here means that the content of a setting value of the dependency source affects the content of a setting value of the dependency destination.

Column 411 shows setting items of the security policy setting which serve as the dependency source, and conditions in which the dependence occurs.

Column 412 shows setting items which serve as the dependency destination, and shows how each setting value is forced when the dependence has occurred.

For example, with regard to the setting item “Prohibit the use of direct connection” of the security policy setting indicated by the item ID “10001”, the case where the setting value of the corresponding setting item is “ON”, i.e., is enabled, affects the setting value of the dependency destination. In that case, the setting value of the setting item “Direct connection setting” indicated by the item ID “00001” is forced into “OFF” and the setting value of the setting item “Automatic start of easy connection” indicated by the item ID “00002” is also forced into “OFF”, i.e., into disabled.

Moreover, for example, with regard to the setting item “Minimum number of characters of password” of the security policy setting indicated by the item ID “10007”, the case where the setting value of the corresponding setting item is a value of one of integers “1” to “32” affects the setting value of the dependency destination. In that case, the setting value of the setting item “Rule: Minimum number of characters” indicated by the item ID “01005” is forced into the same value as a value which is set in the setting item “Minimum number of characters of password” of the security policy setting.

Moreover, for example, with regard to the setting item “Permit transmission only to a destination previously registered with an address book” of the security policy setting indicated by the item ID “10012”, the case where the setting value of the corresponding setting item is “ON”, i.e., is enabled, affects the setting value of the dependency destination. In that case, the setting value of the setting item “Permit addition of a new address” indicated by the item ID “02001” is forced into “OFF”, i.e., is disabled, and, additionally, with regard to all of the pieces of address information written in rows of the item ID “02002” and subsequent item IDs, changing of the setting value thereof is prohibited.

While FIG. 7 illustrates the dependency relationship 410 between a security policy setting and other settings in tabular form, the form for use in retaining such information in the image processing apparatus 200 is not limited to this. For example, the dependency relationship 410 can be retained in specific database form, can be retained in another form such as JSON form, or can be expressed as a program stored in the ROM 213.

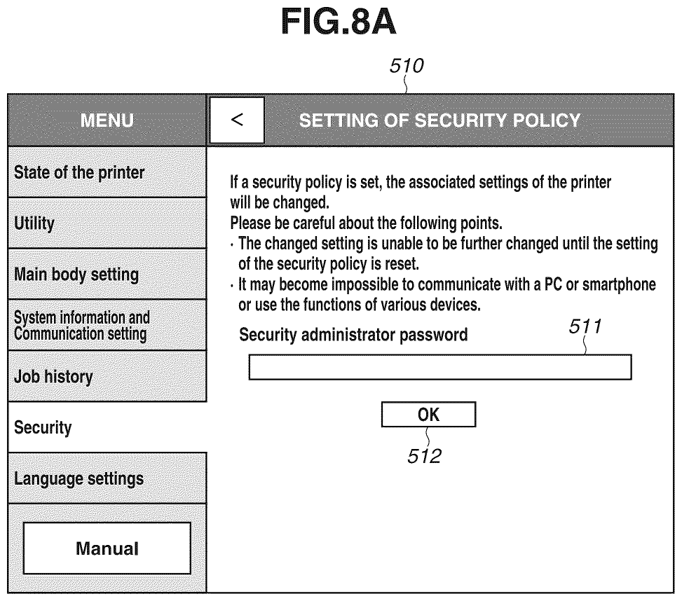

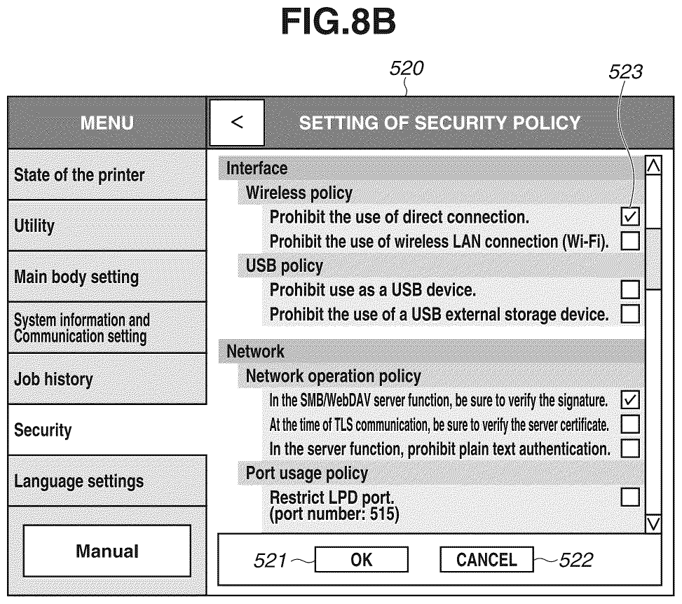

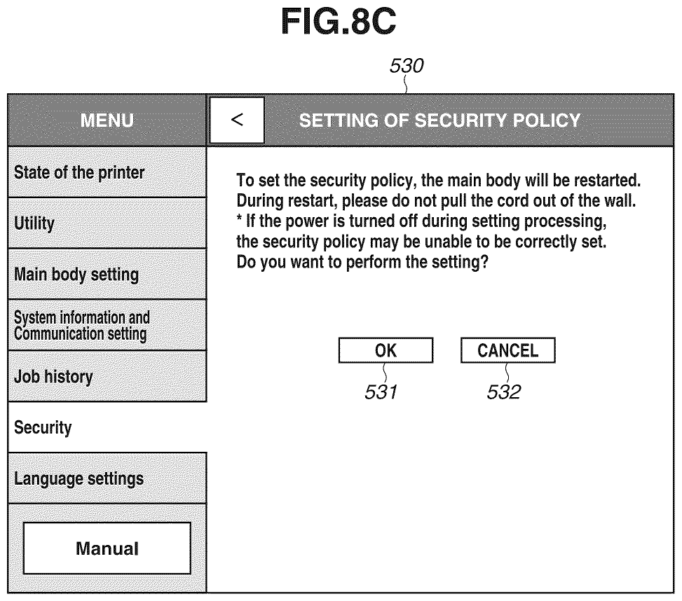

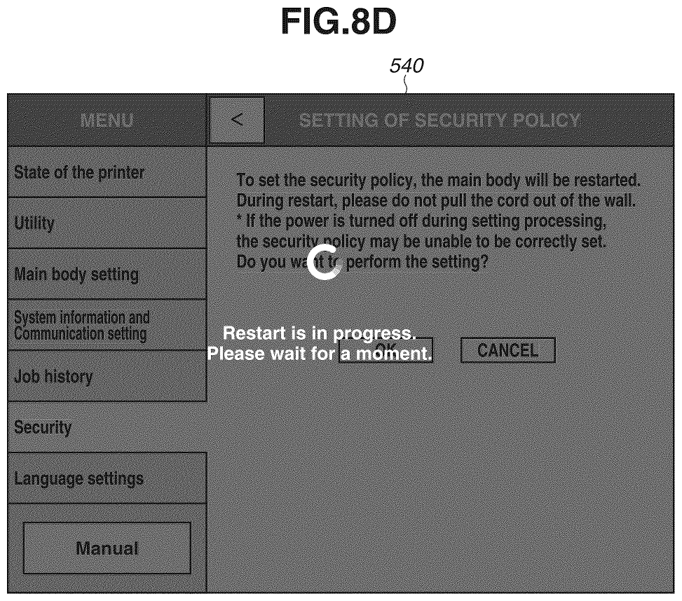

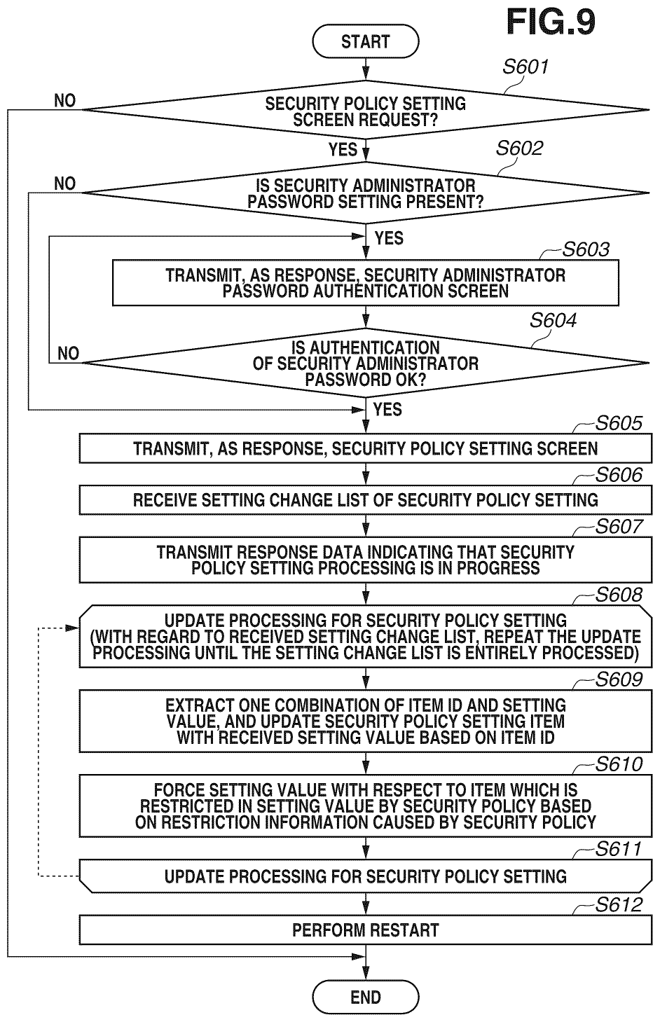

Next, processing which is performed in the case of performing security policy setting via a web UI is described with reference to FIGS. 8A, 8B, 8C, and 8D and FIG. 9.

FIGS. 8A, 8B, 8C, and 8D are diagrams illustrating examples of screens which the web browser of the terminal device 300 displays at the time of setting of a security policy in the present exemplary embodiment.

FIG. 9 is a flowchart illustrating an example of security policy setting processing which is performed by the image processing apparatus 200 in the present exemplary embodiment. Processing operations in steps illustrated in FIG. 9 are performed by the CPU 211 executing a program stored in the ROM 213. Processing illustrated in the flowchart of FIG. 9 is started in response to the web server module 244 of the image processing apparatus 200 receiving an HTTP request described below output from the web browser of the terminal device 300.

In step S601 illustrated in FIG. 9, the web server module 244 checks whether the received HTTP request is a security policy setting screen request. Whether the received HTTP request is a security policy setting screen request is determined based on a requested Uniform Resource Locator (URL) or a request parameter. If it is determined that the received HTTP request is not a security policy setting screen request (NO in step S601), the web server module 244 ends the processing in the present flowchart. Furthermore, while, since the actual image processing apparatus is also able to receive a request other than the security policy setting screen request, the web server module 244 performs processing for continuing to check whether the received HTTP request is another receivable request, this processing deviates from the gist of the present description and is, therefore, omitted from description.

On the other hand, if it is determined that the received HTTP request is a security policy setting screen request (YES in step S601), the web server module 244 requests the web UI control module 251 to generate a security policy setting screen. In response to this request, the web UI control module 251 performs a processing operation in step S602.

In step S602, the web UI control module 251 determines whether security administrator password setting is present. Specifically, the web UI control module 251 acquires the setting value of security administrator password setting from the NVRAM 215 via the security policy setting application 253 and the setting value storing module 262. If the acquired setting value is “ON”, the web UI control module 251 determines that security administrator password setting is present, and, if the acquired setting value is “OFF”, the web UI control module 251 determines that security administrator password setting is not present.

Here, if it is determined that security administrator password setting is present (YES in step S602), the web UI control module 251 advances the processing to step S603.

On the other hand, if it is determined that security administrator password setting is not present (NO in step S602), the web UI control module 251 advances the processing to step S605.

In step S603, the web UI control module 251 generates a security administrator password authentication screen, and transmits, as a response, the security administrator password authentication screen to the terminal device 300 via the web server module 244.

FIG. 8A illustrates an example of a screen 510 which the web browser of the terminal device 300 displays upon receiving the security administrator password authentication screen which the image processing apparatus 200 has transmitted as a response.

An entry field 511 is an entry field for a security administrator password, and an OK button 512 is a button operable for performing authentication using the security administrator password. When a security administrator password has been entered into the entry field 511 by the user and the OK button 512 has been pressed by the user, information about the entered security administrator password is transmitted to the image processing apparatus 200 by the web browser of the terminal device 300.

Then, the description refers back to the flowchart of FIG. 9.

In step S604, the web UI control module 251 receives, via the web server module 244, an HTTP request including the information about a security administrator password which the terminal device 300 has transmitted, and performs authentication of the security administrator password. Specifically, the web UI control module 251 compares the received information about a security administrator password and a “security administrator password value” stored in the NVRAM 215 with each other, and determines the success or failure of the authentication based on whether the received information and the “security administrator password value” coincide with each other.

Here, in a case where the received password and the stored password do not coincide with each other, the web UI control module 251 determines that the security administrator password authentication is failed (NO in step S604), the web UI control module 251 returns the processing to step S603, and then transmits, as a response, a security administrator password authentication screen again to the web browser of the terminal device 300 and performs control to prompt the user to re-enter a password.

On the other hand, in a case where the received password and the stored password coincide with each other, the web UI control module 251 determines that the security administrator password authentication is successful (YES in step S604), and then, the web UI control module 251 advances the processing to step S605.

In step S605, the web UI control module 251 generates a security policy setting screen, and transmits, as a response, the security policy setting screen to the terminal device 300 via the web server module 244.

FIG. 8B illustrates an example of a screen 520 which the web browser of the terminal device 300 displays upon receiving the security policy setting screen which the image processing apparatus 200 has transmitted as a response.

In a region 523, various setting items concerning the security policy are displayed together with, for example, checkboxes or text boxes for enabling the respective settings. The user, who operates the web browser of the terminal device 300, is able to change the security policy setting of the image processing apparatus 200 by operating, for example, the above-mentioned checkboxes or text boxes.

A cancel button 522 is a button operable for stopping the security policy setting. When the cancel button 522 is pressed by the user, an HTTP request for requesting a menu screen higher by one rank than the security policy setting menu is transmitted from the web browser. Then, the image processing apparatus 200 generates and transmits, as a response, data about the requested screen, and the processing in the flowchart of FIG. 9 ends.

An OK button 521 is a button operable for fixing changing of the security policy setting. When the OK button 521 is pressed by the user, a setting change list for the security policy setting operated via the screen 520 (hereinafter referred to as a “setting change list”) is temporarily stored in the web browser, and then, the screen 520 transitions to a screen illustrated in FIG. 8C.

FIG. 8C illustrates an example of a security policy setting execution confirmation screen 530.

A cancel button 532 is a button operable for cancelling transmission of the setting change list.

When the cancel button 532 is pressed by the user, the web browser displays the screen 520 again. At this time, the web browser reads out the temporarily stored setting change list, and performs displaying in a state in which the settings in the setting change list are applied to, for example, applicable checkboxes or text boxes in the region 523.

An OK button 531 is a button operable for transmitting the setting change list. In response to the OK button 531 being pressed by the user, an HTTP request including the setting change list temporarily stored in the web browser is transmitted to the image processing apparatus 200. Here, the setting change list is, for example, information obtained by combining, in list form, values of the item IDs and changed setting values of the applicable setting items with regard to rows included in the category “Security policy setting” in the column 401 illustrated in FIGS. 6A and 6B.

Then, the description refers back to the flowchart of FIG. 9.

In step S606, the web UI control module 251 receives, via the web server module 244, an HTTP request including the setting change list which the terminal device 300 has transmitted, and starts change processing of the security policy setting. Here, the web UI control module 251 generates response data indicating that the security policy setting processing is in progress.

Next, in step S607, the web UI control module 251 transmits, as a response, an HTTP response including the response data indicating that the security policy setting processing is in progress to the terminal device 300 via the web server module 244. Additionally, the web UI control module 251 passes the above-mentioned received setting change list to the security policy setting application 253.

Here, FIG. 8D illustrates an example of a screen 540 which the web browser of the terminal device 300 displays upon receiving the response data indicating that the security policy setting processing is in progress which the image processing apparatus 200 has transmitted as a response.

In the screen 540, the web browser operates in such a way as not to receive an operation performed by the user. Then, the web browser periodically inquires whether the security policy setting processing has been completed, in the background processing for the web browser, and, in a case where the security policy setting processing has been completed, operates in such a way as to display a top screen for the web UI of the image processing apparatus 200 (not illustrated).

Then, the description refers back to the flowchart of FIG. 9.

The security policy setting application 253, to which the setting change list has been passed from the web UI control module 251, performs repetitive processing illustrated in step S608 to step S611. The repetitive processing is repeated with regard to the received setting change list until the setting change list is entirely processed.

In the repetitive processing, first, in step S609, the security policy setting application 253 acquires one combination of an item ID and a setting value unprocessed in the repetitive processing from the setting change list. Then, the security policy setting application 253 stores the setting change of the acquired one combination in the NVRAM 215 via the setting value storing module 262. Here, since the setting value is stored based on the item ID, it is possible to update a designated item in the security policy setting.

Next, in step S610, the security policy setting application 253 performs limitation processing of a setting value based on the dependency relationship 410 between the security policy setting and other settings such as that illustrated in FIG. 7. As specifically described with reference to FIG. 7, the security policy setting application 253 checks a row which coincides with the item ID of the security policy setting stored at this time with regard to the column 411, and checks whether the stored setting value coincides with a “Setting value in causing a limitation to occur in another setting item”. If the stored setting value coincides with a “Setting value in causing a limitation to occur in another setting item”, the security policy setting application 253 forces a setting value with respect to a setting item at the dependency destination as illustrated in the column 412. For example, if the setting change of the acquired one combination is “item ID 10001, ON”, the security policy setting application 253 stores “OFF” as the setting value of the item ID 00001 and “OFF” as the setting value of the item ID 00002 in the NVRAM 215 via the setting value storing module 262.

Next, in step S611, if an unprocessed combination remains in the setting change list, the security policy setting application 253 returns the processing to step S608, and, if the processing is complete with respect to all of the combinations in the setting change list, the security policy setting application 253 advances the processing to step S612.

In step S612, the security policy setting application 253 requests the system control module 261 to restart the image processing apparatus 200. In response to such a request, the system control module 261 performs restart processing, and then, the processing in the present flowchart ends.

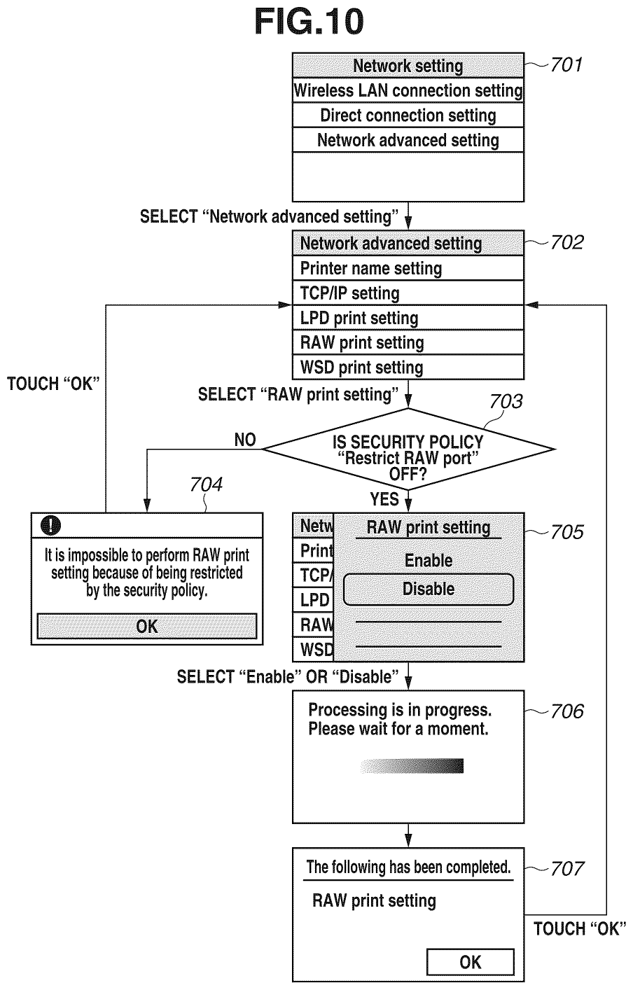

FIG. 10 is a diagram illustrating examples of setting screens for setting items the setting change of which is limited by the security policy in the present exemplary embodiment.

FIG. 10 illustrates a screen flow occurring in the case of trying to operate and display a RAW print setting as an example of how a UI operation of the image processing apparatus 200 is limited by the security policy setting. Furthermore, the screen flow illustrated in FIG. 10 is processed by the CPU 211 executing a program stored in the ROM 213, and, mainly, the device UI control module 252 takes charge of control of the screen flow.

A screen 701 is a network setting menu screen which is displayed in a case where the region 234 (FIG. 4) has been touched in a state in which the home screen (FIG. 4) is being displayed on the touch display 226 of the image processing apparatus 200. In response to “Network advanced setting” in the screen 701 being touched, the screen 701 transitions to a screen 702.

Next, in response to “RAW print setting” in the screen 702 being touched, the screen flow proceeds to determination 703.

In determination 703, the device UI control module 252 acquires, via the security policy setting application 253, a setting value indicating whether the security policy setting item ID 10004 “Restrict RAW port” is “OFF”, i.e., is disabled. In a case where the acquired value indicates that the security policy setting item ID 10004 “Restrict RAW port” is “ON”, i.e., is enabled (NO in determination 703), the screen 702 transitions to a screen 704.

The screen 704 notifies the user that the setting change of RAW print setting is currently limited by the security policy setting, and, in response to an OK button in the screen 704 being pressed, the screen 704 returns to the screen 702.

On the other hand, in a case where the acquired value indicates that the security policy setting item ID 10004 “Restrict RAW port” is “OFF”, i.e., is disabled (YES in determination 703), the screen 702 transitions to a screen 705.

In the screen 705, options of RAW print setting are displayed, and, in the case of the screen 705, in response to any one of “Enable” or “Disable” being touched, the screen 705 transitions to a screen 706.

In the screen 706, a screen for notifying the user that the setting change processing is in progress is displayed, so that the setting change of the image processing apparatus 200 is performed.

For example, in a case where “Enable” has been touched in the screen 705, the device UI control module 252 changes the setting value of the item ID 00009 “RAW print setting” to “ON” via the NW setting application 254 or the setting value storing module 262.

On the other hand, in a case where “Disable” has been touched in the screen 705, the device UI control module 252 changes the setting value of the item ID 00009 “RAW print setting” to “OFF” in a similar way.

Upon completion of the processing for the setting change of the image processing apparatus 200, the screen 706 transitions to a screen 707, thus notifying the user of the completion of the setting change. In response to an OK button in the screen 707 being pressed, the screen 707 returns to the screen 702.

Furthermore, while FIG. 10 illustrates a case where the setting change is performed by a UI operation on the main body of the image processing apparatus 200, the method for the setting change is not limited to this. For example, the setting change can be implemented by a web UI, and, in that case, a setting change procedure or a limitation of setting change similar to that in the screen flow illustrated in FIG. 10 can also be performed.

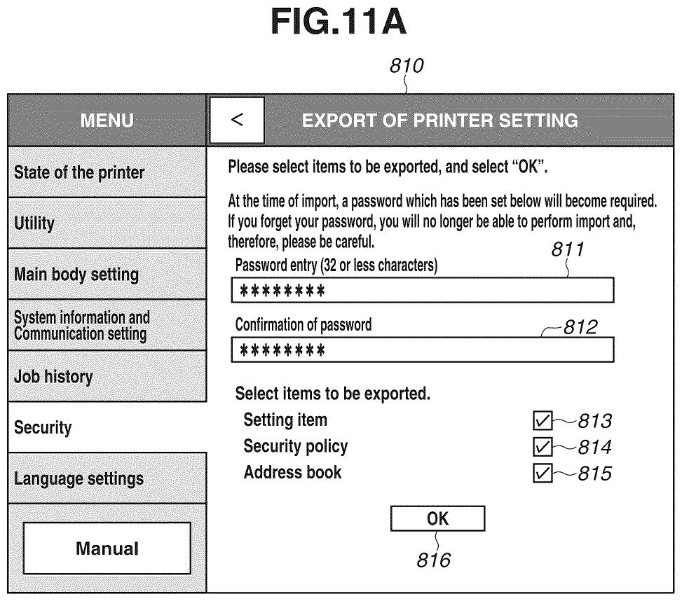

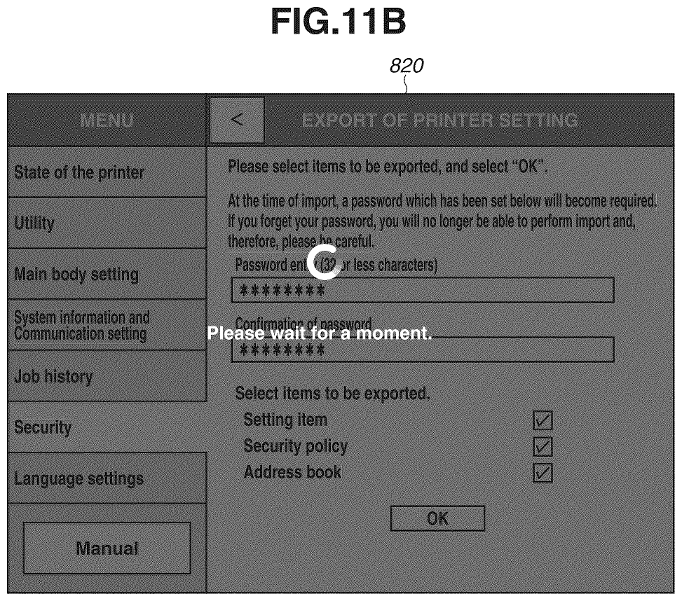

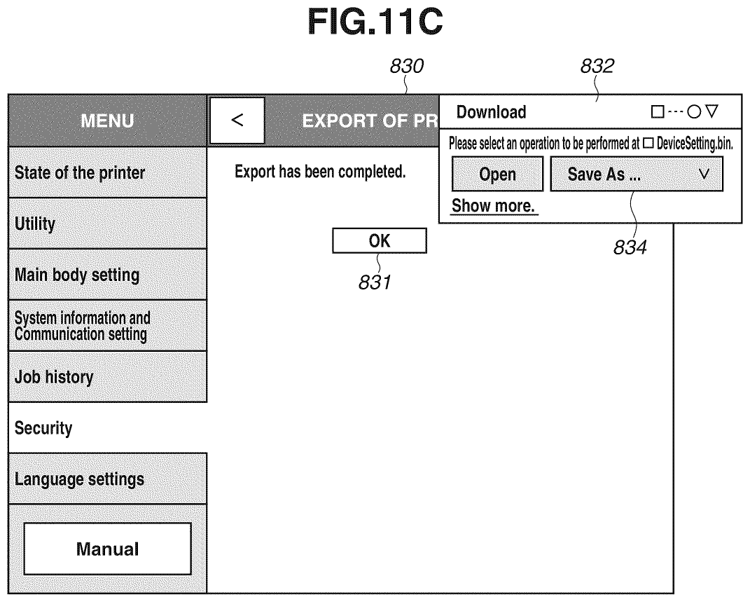

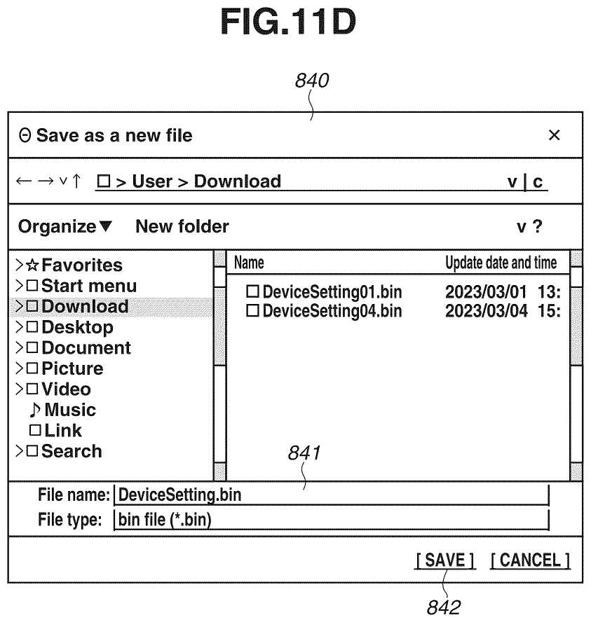

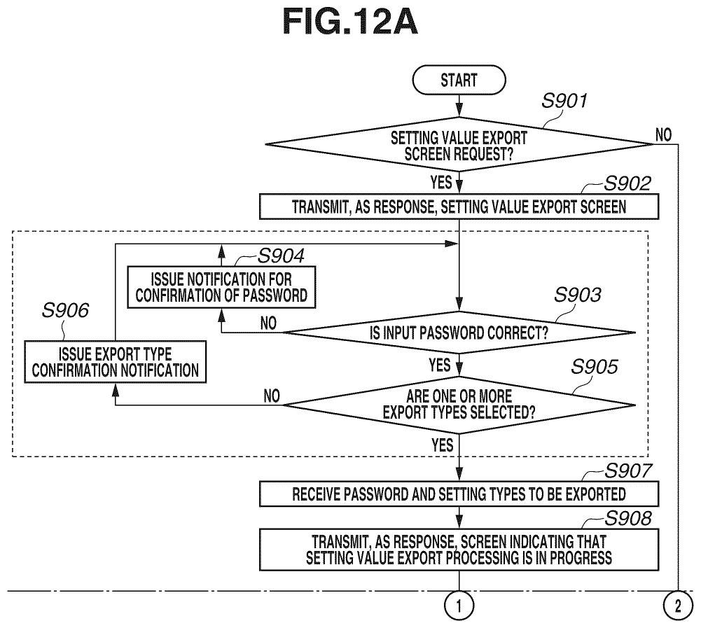

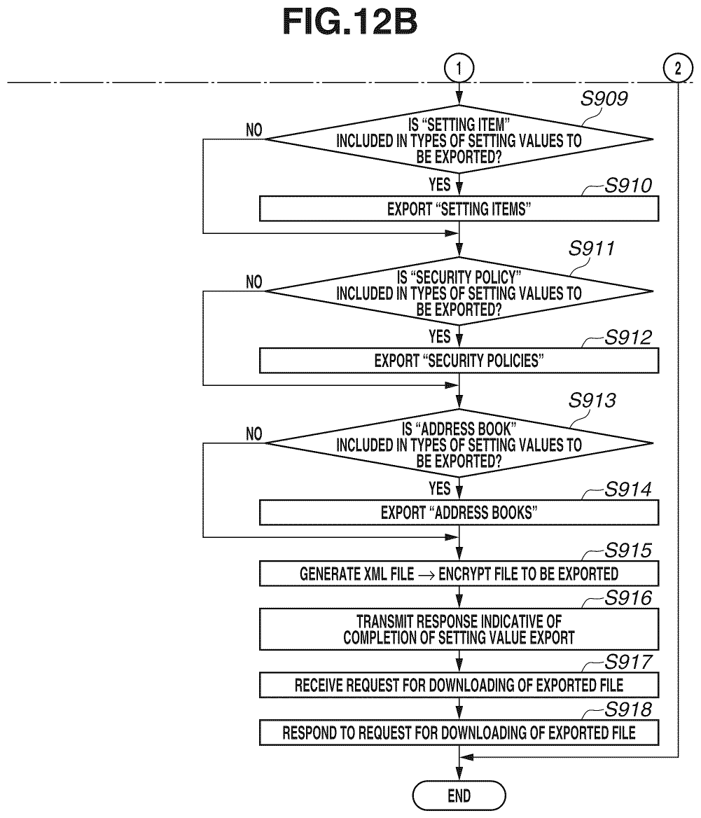

Next, processing which is performed in the case of performing export of setting values via a web UI is described with reference to FIGS. 11A, 11B, 11C, and 11D and FIGS. 12A and 12B.

In the present exemplary embodiment, a use case where a file exported from the image processing apparatus 200 is imported to the same image processing apparatus 200 is described on the assumption that, for example, all of the device settings are backed up due to manufacturer repair and, after repair, all of the device settings are restored. The back-up mentioned here means exporting setting values, and the restore mentioned here means importing the exported setting values and restoring to original state.

FIGS. 11A, 11B, 11C, and 11D are diagrams illustrating examples of screens which the web browser of the terminal device 300 displays at the time of export of setting values in the present exemplary embodiment.

FIGS. 12A and 12B are flowcharts illustrating an example of setting value export processing which is performed by the image processing apparatus 200 in the present exemplary embodiment. In FIG. 12A, a portion surrounded by a dashed line represents processing which is performed by the terminal device 300. Processing operations in steps of the image processing apparatus 200 illustrated in FIGS. 12A and 12B are performed by the CPU 211 executing a program stored in the ROM 213. Moreover, processing operations in steps of the terminal device 300 are performed by a CPU executing a program stored in a storage device such as a solid state drive (SSD) (not illustrated) of the terminal device 300.

Processing illustrated in the flowcharts of FIGS. 12A and 12B is started in response to the web server module 244 of the image processing apparatus 200 receiving an HTTP request described below output from the web browser of the terminal device 300.

In step S901, the web server module 244 determines where the received HTTP request is a setting value export screen request, and, if it is determined that the received HTTP request is not a setting value export screen request (NO in step S901), the web server module 244 ends the processing in the present flowchart. Furthermore, while, since the actual image processing apparatus is also able to receive a request other than the setting value export screen request, the web server module 244 performs processing for continuing to check whether the received HTTP request is another receivable request, this processing deviates from the gist of the present description and is, therefore, omitted from description.

On the other hand, if it is determined that the received HTTP request is a setting value export screen request (YES in step S901), the web server module 244 requests the web UI control module 251 to generate a setting value export screen. In response to this request, the web UI control module 251 performs a processing operation in step S902.

In step S902, the web UI control module 251 generates a setting value export screen, and transmits, as a response, the setting value export screen to the terminal device 300 via the web server module 244.

FIG. 11A illustrates an example of a screen 810 which the web browser of the terminal device 300 displays upon receiving the setting value export screen which the image processing apparatus 200 has transmitted as a response.

An OK button 816 is a button operable for issuing an instruction for execution of setting value export. In response to the OK button 816 being pressed by the user, the terminal device 300 temporarily stores, in the web browser thereof, a password character string described below which has been set in the screen 810 and a setting type which is to be exported, and, before causing the screen 810 to transition to a screen illustrated in FIG. 11B, performs subsequent processing operations for determining whether the entered contents are correct (step S903 to step S906 illustrated in FIG. 12A).

Entry fields 811 and 812 are used to enter a password character string which is provided for encrypting file contents at the time of exporting setting values and is required to, at the time of import, decrypt the file contents with the password entered at the time of export. The password to be entered by the user is required to be entered two times for confirmation. Processing for determining whether the contents entered into the entry fields 811 and 812 are correct is as follows. If a character string for password confirmation entered into the entry field 812 does not coincide with a character string entered into the entry field 811, the terminal device 300 generates a screen (not illustrated) for confirming a password and notifies the user of the generated screen. This portion is determination processing indicated in step S903 illustrated in FIG. 12A, and the screen of which the user is notified (the screen (not illustrated) for confirming a password) is displayed in step S904.

Next, checkboxes 813 to 815 are controls which allow the user to select types of setting values to be exported. The checkbox 813 is a control for selecting setting values of a setting item group which affects at least one or more actions of the image processing apparatus 200 as a type of setting values to be exported. The checkbox 814 is a control for selecting setting values of the security policy setting as a type of setting values to be exported. The checkbox 815 is a control for selecting setting values of an address book not included in the setting item for the checkbox 813 as a type of setting values to be exported. At least one or more of these checkboxes are required to be selected. Processing for determining whether the contents input at the checkboxes 813 to 815 are correct is as follows. In a case where there is no selection, the terminal device 300 generates a screen (not illustrated) for prompting the user to perform selection and notifies the user of the generated screen. This portion is determination processing indicated in step S905 illustrated in FIG. 12A, and processing for displaying a screen of which the user is notified if the result of the determination is NO (the screen (not illustrated) for prompting the user to perform selection) is assumed to be performed in step S906.

The terminal device 300 temporarily stores, in the web browser thereof, the password entered by the user and the checked types of setting values, and, in response to the OK button 816 being pressed, determines whether the input contents are correct (step S903 to step S905). Then, if the input contents are correct (YES in step S903 and YES in step S905), the terminal device 300 sends the input contents (the password and the types of setting values to be exported) together with an HTTP request to the image processing apparatus 200.

Then, the description refers back to the flowcharts of FIGS. 12A and 12B.

In step S907, the web UI control module 251 receives (accepts), via the web server module 244, an HTTP request (including the password and the types of setting values to be exported) transmitted from the terminal device 300.

Next, in step S908, the web UI control module 251 starts setting value export processing using the password and the types of setting values to be exported received in step S907 mentioned above and, at the same time, generates a screen 820 indicating that setting value export processing is in progress and transmits the generated screen 820 as a response. Furthermore, the web UI control module 251 passes, to the setting value export application 256b, the password and the types of setting values to be exported included in the HTTP request received from the terminal device 300 in step S907 mentioned above and causes the setting value export application 256b to perform setting value export processing.

FIG. 11B illustrates an example of a screen 820 which the web browser of the terminal device 300 displays upon receiving the screen indicating that setting value export processing is in progress which the image processing apparatus 200 has transmitted as a response.

In the screen 820 transmitted as a response in step S908 illustrated in FIG. 12A, the web browser operates in such a way as not to receive an operation performed by the user, and then, periodically inquires whether the setting value export processing has been completed, in the background processing for the web browser. When the setting value export processing has been completed, the web UI control module 251 generates response data indicating that the setting value export processing has been completed and then transmits the generated response data as a response via the web server module 244 (step S916 described below). Upon receiving the response data, the web browser causes the screen 820 to transition to a screen 830 illustrated in FIG. 11C.

FIG. 11C illustrates an example of the screen 830, which the web browser of the terminal device 300 displays upon receiving the response data indicating that the setting value export processing has been completed which the image processing apparatus 200 has transmitted as a response.

Here, the web browser of the terminal device 300 transmits, to the image processing apparatus 200, a download request for a file obtained by exporting the setting values generated by the setting value export application 256b of the image processing apparatus 200. The image processing apparatus 200 returns an HTTP response responsive to the download request via the web server module 244. At this time, in the case of downloading of the exported file, as with an ordinary file download by the web browser, a download selection dialog box 832 for allowing the user to select handling of the downloaded file is displayed, thus bring about a state for awaiting the user input.

In this state, in the present exemplary embodiment, when a Save As button 834 is pressed by the user, the terminal device 300 stores, in a storage device (not illustrated) of the terminal device 300, the downloaded file with a desired file name designated in a file selection screen such as that illustrated in FIG. 11D.

FIG. 11D illustrates an example of a general-purpose selection screen 840 which is displayed to “save as a new file” a file to be downloaded. In the general-purpose selection screen 840, after designation of a location for storing a file and selection of a file name or entry of a file name into an entry field 841, the file is stored in response to a save button 842 being pressed.

Then, the description refers back to the flowcharts of FIGS. 12A and 12B.

In step S909, the setting value export application 256b refers to types of setting values to be exported passed from the web UI control module 251, and determines whether a setting item is included in the types of setting values to be exported.

Here, if it is determined that a setting item is included in the types of setting values to be exported (YES in step S909), the setting value export application 256b advances the processing to step S910.

On the other hand, if it is determined that no setting item is included in the types of setting values to be exported (NO in step S909), the setting value export application 256b advances the processing to step S911, which is determination of a next export type.

In step S910, the setting value export application 256b performs export processing for setting items. In the export processing for setting items, the setting value export application 256b loads and generates, on the RAM 214, a list of setting values targeted for export included in the currently set setting values retained in the NVRAM 215, via the setting value storing module 262. Next, the setting value export application 256b converts the list of setting values generated on the RAM 214 into the extended markup language (XML) format and outputs the converted list to a temporary buffer for file output similarly loaded on the RAM 214. In a case where the type for export is a setting item, a configuration in which the type for export is able to be discriminated from another export type with an XML tag by, for example, setting <DeviceSettings> as an example of a tag which is a middle item of XML is employed.

Furthermore, while, in the present exemplary embodiment, the format of data to be exported is the XML format, the present exemplary embodiment is not limited to this, and another data format can be employed. For example, the comma separated value (CSV) format, the JSON format, or a unique binary format for directly mapping a structured data structure on a memory can also be employed. Moreover, the setting value export application 256b is retaining information retained in the NVRAM 215 described above with regard to the setting item management information 400, and appends information about, for example, an attribute associated with a setting value to data to be exported together with the setting value. These pieces of information are composed of a data type which represents, for example, the size or type of value data about each setting item or, in the case of arrays, the number of arrays, and the maximum value and minimum value of data, and may include, for example, a level value which defines how far to allow a device revision at the time of import. Furthermore, the setting value export application 256b sets information to be exported in common between devices at the beginning of export processing. These pieces of information are, for example, values including, for example, a serial number for identifying a type of device or an individual and version information about firmware running in the device. Arranging these pieces of information at an upper-level portion of XML causes them to be analyzed in the early stage at the time of import and enables controlling import processing of each setting value. Here, a configuration in which the type of device is able to be discriminated from another type by, for example, setting <DeviceInformation> as an example of an identification tag in the XML format of information to be exported in common between devices is employed.

Next, when export of setting items is complete and data in the XML format is once complete, the setting value export application 256b advances the processing to step S911, which is determination of a next export type.

In step S911, the setting value export application 256b refers to types of setting values to be exported passed from the web UI control module 251, and determines whether a security policy is included in the types of setting values to be exported.

Here, if it is determined that a security policy is included in the types of setting values to be exported (YES in step S911), the setting value export application 256b advances the processing to step S912.

On the other hand, if it is determined that no security policy is included in the types of setting values to be exported (NO in step S911), the setting value export application 256b advances the processing to step S913, which is determination of a next export type.

In step S912, the setting value export application 256b performs export processing for security policies. In the export processing for security policies, the setting value export application 256b loads and generates, on the RAM 214, a list of enabled security policies out of the security policies retained in the NVRAM 215, via the setting value storing module 262. Each security policy is managed in such a manner that the updated content thereof is controlled by the security policy setting application 253 and the up-to-data state thereof is always retained in the setting value storing module 262. In a case where, in step S910, which is an immediately preceding step, export of setting items has been performed, output data is present with the XML format in a temporary buffer for file output loaded on the RAM 214, but, in a case where export of setting items is not performed, output data becomes XML data in which only an identification tag in common between devices is present. In any case, even in export processing for security policies, as with setting items, the setting value export application 256b generates XML data while composing tags to be exported based on respective pieces of information included in the setting item management information 400, and then concatenates the XML data with character string data retained in the temporary buffer. Here, in a case where the type for export is a security policy, a configuration in which the type for export is able to be discriminated from another export type with an XML tag by, for example, setting <SecurityPolicySettings> as an example of a tag which is a middle item of XML is employed.

Next, when export of security policies is complete and data in the XML format is once complete, the setting value export application 256b advances the processing to step S913, which is determination of a next export type.

In step S913, the setting value export application 256b refers to types of setting values to be exported passed from the web UI control module 251, and determines whether an address book is included in the types of setting values to be exported.

Here, if it is determined that an address book is included in the types of setting values to be exported (YES in step S913), the setting value export application 256b advances the processing to step S914.

On the other hand, if it is determined that no address book is included in the types of setting values to be exported (NO in step S913), the setting value export application 256b advances the processing to step S915.

In step S914, the setting value export application 256b performs export processing for address books. In the export processing for address books, the setting value export application 256b loads and generates, on the RAM 214, a list of address books retained in the NVRAM 215, via the setting value storing module 262. Each address book is managed in such a manner that the updated content thereof is controlled by the address book setting application 255 and the up-to-data state thereof is always retained in the setting value storing module 262. Since constituent information stored in each address book includes, as character strings, pieces of stylized information such as the full name of a registrant, the name of an organization, and a telephone number or e-mail address, the setting value export application 256b generates address book data by invoking a module which acquires such pieces of information from the address book setting application 255, which comprehensively manages such pieces of information. Specifically, the setting value export application 256b acquires individual IDs retained in an address book from the setting value storing module 262, and generates XML format data by using a module which acquires detailed information which the address book setting application 255 provides according to the acquired IDs. The setting value export application 256b sequentially concatenates the generated XML format address data for one address with existing XML character string data retained in the temporary buffer, and thus finally composes all of the addresses. Furthermore, in a case where the type for export is an address book, a configuration in which the type for export is able to be discriminated from another export type with an XML tag by, for example, setting <AddressBook> as an example of a tag which is a middle item of XML is employed.

When, out of the above-mentioned three export types, all of the export processing operations selected as the types of setting values to be exported have been completed, the setting value export application 256b advances the processing to step S915.

In step S915, the setting value export application 256b concatenates a closing tag so as to complete XML data retained in the temporary buffer for file output loaded on the RAM 214, and also performs encryption thereon using a password. Furthermore, while, in the present exemplary embodiment, an XML format data file is exported as a compressed file with a ZIP format password, the present exemplary embodiment is not limited to this method. For example, instead of the ZIP format, an encryption library which a third vendor provides can be used, and, instead of archiving the entire file by a password, the Advanced Encryption Standard (AES) encryption using OpenSSL can be performed on a portion serving as a value included in XML format data.

When the above-mentioned processing operation in step S915 is complete, the setting value export application 256b notifies the web UI control module 251 that the export processing has been completed. In response to this notification, the web UI control module 251 performs a processing operation in step S916.

In step S916, to transmit a response to a periodic request about the processing completion from the terminal device 300, the web UI control module 251 issues an event indicative of export completion to the web server module 244. The web server module 244 forms data indicative of export completion as an HTTP response and transmits the HTTP response to the terminal device 300. The terminal device 300 receives HTTP data indicative of export completion, and performs displaying of, for example, a screen 830 illustrated in FIG. 11C on the web browser thereof.

Next, in step S917, the web UI control module 251 receives, via the web server module 244, a download request for an exported file associated with the setting value export processing completion from the terminal device 300. Here, the name of a file to be downloaded is fixedly determined, and, in the present exemplary embodiment, is assumed to be, for example, “DeviceSetting.bin”.

Next, in step S918, the web UI control module 251 transmits, via the web server module 244, the exported file (for example, “DeviceSetting.bin”), as a response to the above-mentioned download request for an exported file received in step S917, to the web browser of the terminal device 300. This causes the download selection dialog box 832 to be displayed on the web browser of the terminal device 300. Here, when the Save As button 834 is pressed by the user and, in the file selection screen 840 illustrated in FIG. 11D, a file name is designated and the save button 842 is pressed, the exported file is then stored with a desired file name in a storage device (not illustrated) of the terminal device 300.

As described above, it is possible to perform export of setting values.

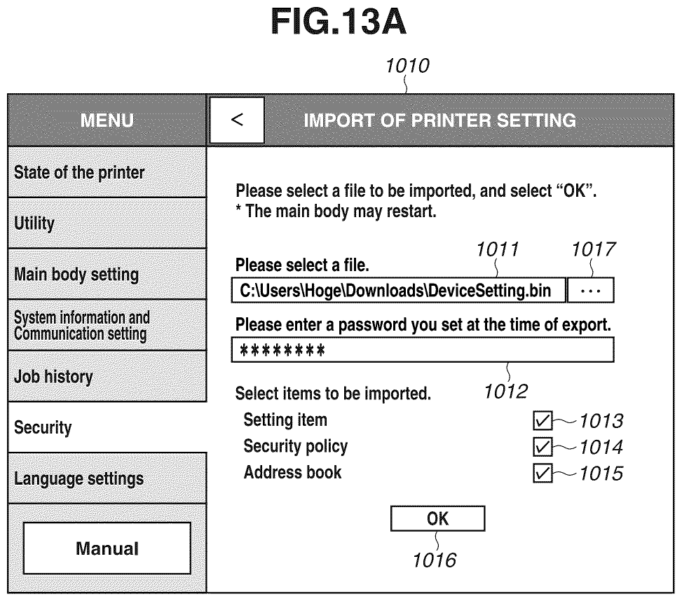

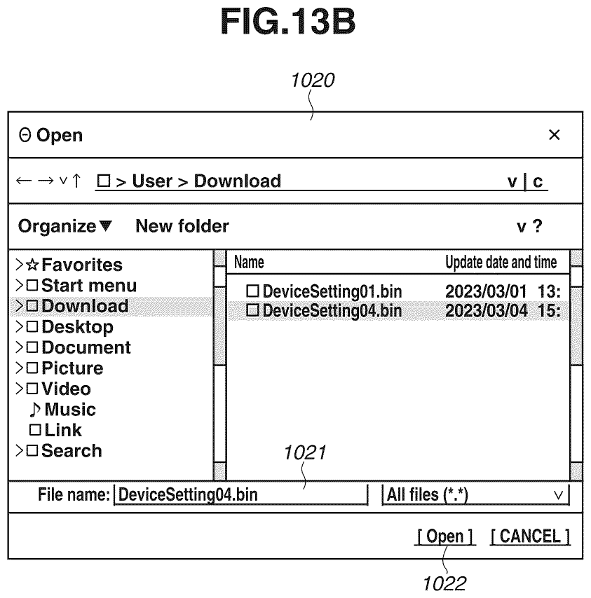

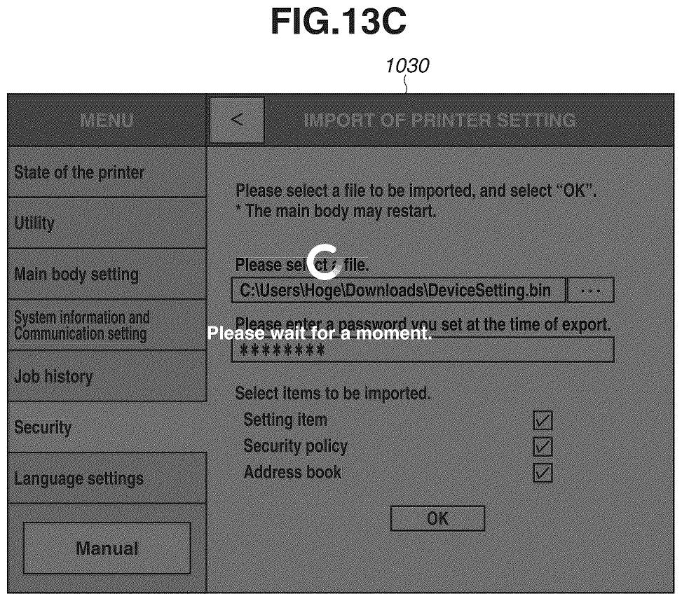

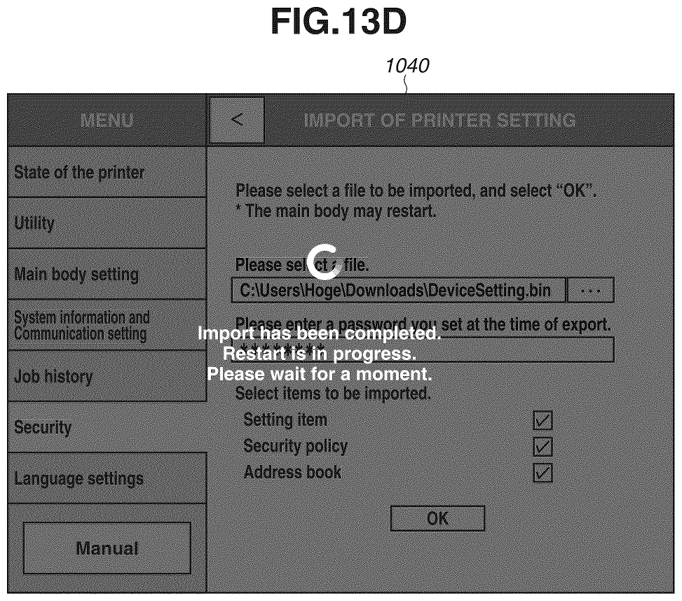

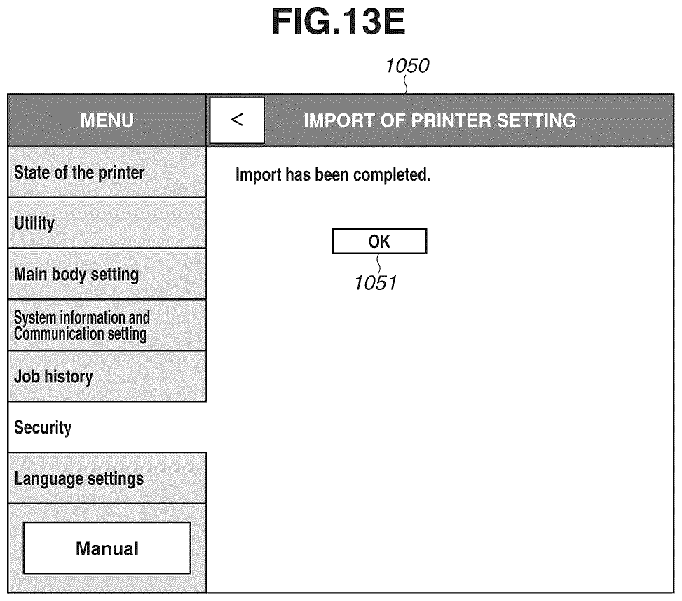

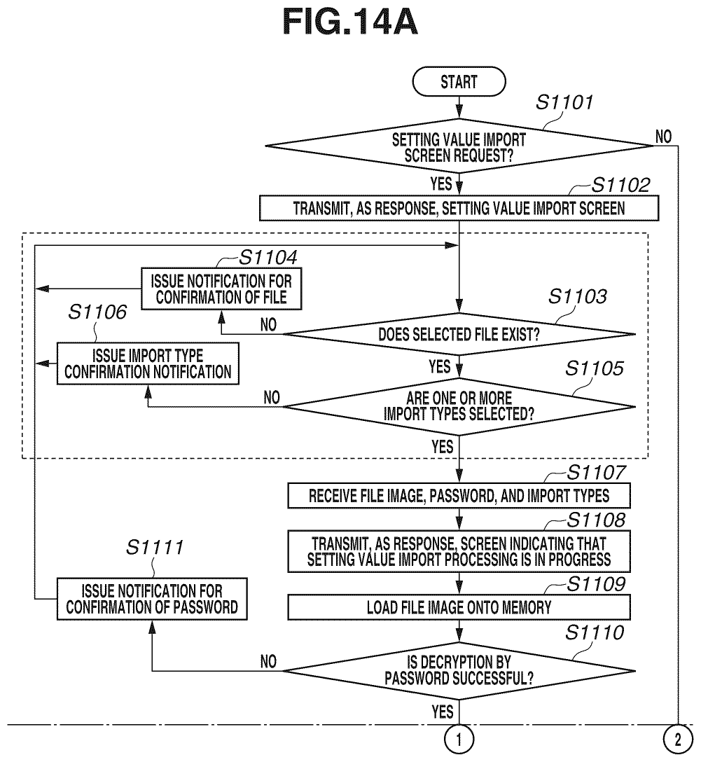

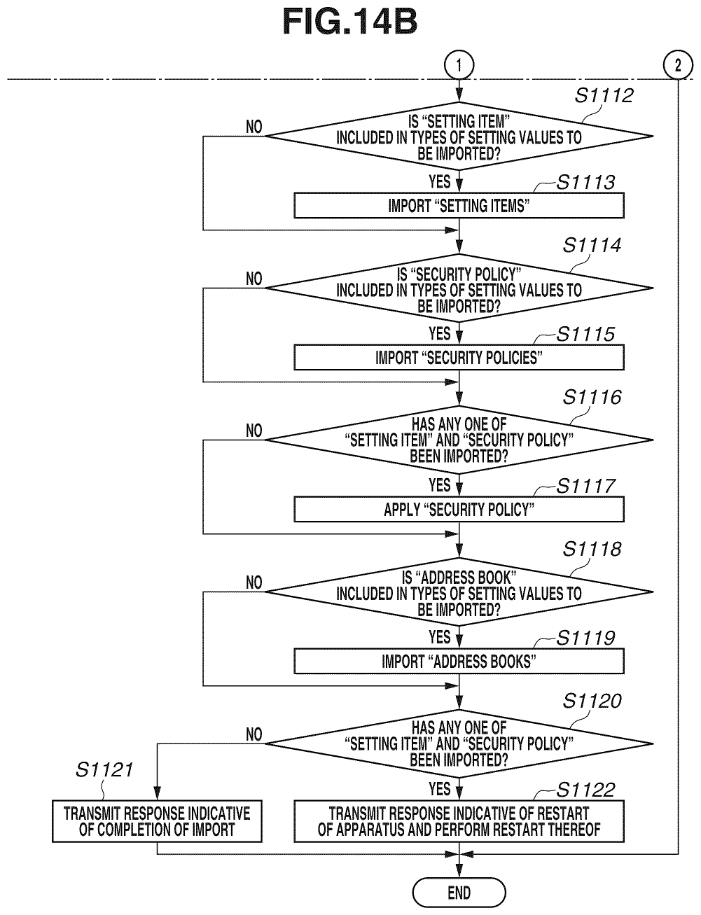

Next, processing which is performed in the case of performing import of setting values via a web UI is described with reference to FIGS. 13A, 13B, 13C, 13D, and 13E and FIGS. 14A and 14B.

FIGS. 13A, 13B, 13C, 13D, and 13E are diagrams illustrating examples of screens which the web browser of the terminal device 300 displays at the time of import of setting values in the present exemplary embodiment.

FIGS. 14A and 14B are flowcharts illustrating an example of setting value import processing which is performed by the image processing apparatus 200 in the present exemplary embodiment. In FIG. 14A, a portion surrounded by a dashed line represents processing which is performed by the terminal device 300. Processing operations in steps of the image processing apparatus 200 illustrated in FIGS. 14A and 14B are performed by the CPU 211 executing a program stored in the ROM 213. Moreover, processing operations in steps of the terminal device 300 are performed by a CPU executing a program stored in a storage device such as a solid state drive (SSD) (not illustrated) of the terminal device 300.

Processing illustrated in the flowcharts of FIGS. 14A and 14B is started in response to the web server module 244 of the image processing apparatus 200 receiving an HTTP request described below output from the web browser of the terminal device 300.

In step S1101, the web server module 244 determines where the received HTTP request is a setting value import screen request, and, if it is determined that the received HTTP request is not a setting value import screen request (NO in step S1101), the web server module 244 ends the processing in the present flowchart. Furthermore, while, since the actual image processing apparatus is also able to receive a request other than the setting value import screen request, the web server module 244 performs processing for continuing to check whether the received HTTP request is another receivable request, this processing deviates from the gist of the present description and is, therefore, omitted from description.

On the other hand, if it is determined that the received HTTP request is a setting value import screen request (YES in step S1101), the web server module 244 requests the web UI control module 251 to generate a setting value import screen. In response to this request, the web UI control module 251 performs a processing operation in step S1102.

In step S1102, the web UI control module 251 generates a setting value import screen, and transmits, as a response, the setting value import screen to the terminal device 300 via the web server module 244.

FIG. 13A illustrates an example of a screen 1010 which the web browser of the terminal device 300 displays upon receiving the setting value import screen which the image processing apparatus 200 has transmitted as a response.

An OK button 1016 is a button operable for issuing an instruction for execution of setting value import. In response to the OK button 1016 being pressed by the user, the terminal device 300 temporarily stores, in the web browser thereof, a file path for import described below set in the screen 1010, a password, and a setting type which is to be imported, and, before causing the screen 1010 to transition to a screen illustrated in FIG. 13C, performs subsequent processing operations for determining whether the entered contents are correct (step S1103 to step S1106 illustrated in FIG. 14A).

An entry field 1011 is used to designate a file to be imported and enter a file path including a file name, and a file name including the designated file path is entered into the entry field 1011 with use of a general-purpose selection screen 1020 for opening a file illustrated in FIG. 13B. In the present exemplary embodiment, in response to a “ . . . ” button 1017 located above or on the right side of the entry field 1011 being pressed, the selection screen 1020 illustrated in FIG. 13B is displayed, in which the user performs file selection by designating a file name at an entry field 1021 and then pressing an “open” button 1022. Furthermore, in a case where the file selected at the time of the OK button 1016 having been pressed by the user is not able to be opened, the result of a determination performed in step S1103 illustrated in FIG. 14A is NO (NO in step S1103), and then in step S1104, the terminal device 300 generates a screen (not illustrated) for prompting the user to check a file and notifies the user of the generated screen. Furthermore, a file to be imported which is designated here is, for example, a file exported by export processing illustrated in FIGS. 12A and 12B, and includes a setting value group targeted for import processing.

An entry field 1012 is used to enter a password character string which is required to, at the time of importing setting values, decrypt the encrypted file.

Checkboxes 1013 to 1015 are controls which allow the user to select types of setting values to be imported. At least one or more of these checkboxes are required to be selected, and, in a case where there is no selection, the terminal device 300 generates a screen (not illustrated) for prompting the user to perform selection and notifies the user of the generated screen. This portion is determination processing indicated in step S1105 illustrated in FIG. 14A, and processing for displaying a screen of which the user is notified if the result of the determination is NO (the screen (not illustrated) for prompting the user to perform selection) is assumed to be performed in step S1106.

The terminal device 300 temporarily stores, in the web browser thereof, the password entered by the user and the checked types of setting values, and, in response to the OK button 1016 being pressed, sends the input contents (the password and the types of setting values to be imported) together with an HTTP request to the image processing apparatus 200. Moreover, the terminal device 300 reads a designated file to be imported into a temporarily allocated memory region and also transmits the designated file as binary format data to the image processing apparatus 200.

Then, the description refers back to the flowcharts of FIGS. 14A and 14B.

In step S1107, the web UI control module 251 receives (accepts), via the web server module 244, an HTTP request (including the file data, the password, and the types of setting values to be imported) transmitted from the terminal device 300.

Next, in step S1108, the web UI control module 251 starts setting value import processing using the file data, the password, and the import types received in step S1107 mentioned above and, at the same time, generates a screen 1030 indicating that setting value import processing is in progress and transmits the generated screen 1030 as a response. Furthermore, the web UI control module 251 passes, to the setting value import application 256a, the file data, the password, and the import types included in the HTTP request received from the terminal device 300 in step S1107 mentioned above and causes the setting value import application 256a to perform setting value import processing.

FIG. 13C illustrates an example of a screen 1030 which the web browser of the terminal device 300 displays upon receiving the screen indicating that setting value import processing is in progress which the image processing apparatus 200 has transmitted as a response.

In the screen 1030 transmitted as a response in step S1108 illustrated in FIG. 14A, the web browser operates in such a way as not to receive an operation performed by the user, and then, periodically inquires whether the setting value import processing has been completed, in the background processing for the web browser. When the setting value import processing has been completed, the web UI control module 251 generates response data indicating that the setting value import processing has been completed and then transmits the generated response data as a response (step S1121 described below). Upon receiving the response data, the web browser causes the screen 1030 to transition to a screen 1040 illustrated in FIG. 13D. However, in a case where import processing has been completed with respect to only address books, since the image processing apparatus 200 does not need to be restarted, the web browser causes the screen 1030 to return to a screen which has been displayed one screen before the screen illustrated in FIG. 13A.

FIG. 13D illustrates an example of a screen 1040 which the web browser of the terminal device 300 displays upon receiving the response data indicating that the setting value import processing has been completed which the image processing apparatus 200 has transmitted as a response. In the screen 1040, the web browser of the terminal device 300 notifies the user that setting value import processing has been completed and the image processing apparatus 200 is then being restarted.

Then, the description refers back to the flowcharts of FIGS. 14A and 14B.

In step S1109, the setting value import application 256a loads (for example, loads in ZIP format), onto the RAM 214, a file image received together with the HTTP request from the terminal device 300 in step S1107 mentioned above, and decrypts the file image by an application programming interface (API) module with use of the password which has been received likewise.

Next, in step S1110, if the setting value import application 256a has failed to decrypt the data on the RAM 214 loaded in ZIP format with use of the password (NO in step S1110), the setting value import application 256a advances the processing to step S1111.

In step S1111, the setting value import application 256a requests the web UI control module 251 to generate a screen (not illustrated) for notifying the user of confirmation of the password and notify the user of the generated screen, and returns the screen to the screen 1010 illustrated in FIG. 13A, to perform control to prompt the user to re-enter a password.

On the other hand, if the setting value import application 256a has succeeded in decrypting the data with use of the password (YES in step S1110), the setting value import application 256a advances the processing to step S1112.

In step S1112, the setting value import application 256a refers to types of setting values to be imported passed from the web UI control module 251, and determines whether a setting item is included in the types of setting values to be imported.

Here, if it is determined that a setting item is included in the types of setting values to be imported (YES in step S1112), the setting value import application 256a advances the processing to step S1113.

On the other hand, if it is determined that no setting item is included in the types of setting values to be imported (NO in step S1112), the setting value import application 256a advances the processing to step S1114, which is determination of a next import type.

In step S1113, the setting value import application 256a performs import processing for setting items. In the import processing for setting items, first, the setting value import application 256a analyzes information in common between devices composed at the time of export from the decrypted file of the XML format, and sets the analyzed information to an array memory allocated for information in common between devices on the RAM 214. This processing is assumed to be performed only once before types to be imported are processed. For example, in a case where a setting item is not a target for import and a security policy is a target for import, the above-mentioned processing is performed before import processing for the security policy. Next, in the case of import of setting items, the setting value import application 256a identifies <DeviceSettings>, which is a tag in a middle item of the decrypted XML, by XML analytical processing, and sets the setting items one by one to arrays allocated as retention regions for setting items on the RAM 214. At this time, the setting value import application 256a refers to information in common between devices, and sets the setting values to the arrays while checking the acceptable level in performing import or checking whether the adequacy of a setting value is correct by referring to the above-mentioned setting value data table. Next, the setting value import application 256a passes the arrays retained in the RAM 214 to which all of the setting items have been set to an application programming interface (API) which the setting value storing module 262 provides, and causes the arrays to be retained in the NVRAM 215.

Next, in step S1114, the setting value import application 256a refers to types of setting values to be imported passed from the web UI control module 251, and determines whether a security policy is included in the types of setting values to be imported.

Here, if it is determined that a security policy is included in the types of setting values to be imported (YES in step S1114), the setting value import application 256a advances the processing to step S1115.

On the other hand, if it is determined that no security policy is included in the types of setting values to be imported (NO in step S1114), the setting value import application 256a advances the processing to step S1116.

In step S1115, the setting value import application 256a performs import processing for security policies. In the import processing for security policies, the setting value import application 256a analyzes <SecurityPolicySettings>, which is a middle item tag of the decrypted XML, by XML analytical processing, and sets the analyzed setting values one by one to arrays allocated as retention regions for security policies on the RAM 214. At this time, the setting value import application 256a refers to information in common between devices, and sets the setting values to the arrays while checking the acceptable level in performing import or checking whether the adequacy of a setting value is correct by referring to the above-mentioned setting value data table. Next, the setting value import application 256a invokes a check module for security policy setting items of the security policy setting application 253 while designating arrays on the RAM 214, and thus checks whether the imported item is undeviating as a setting value of each security policy. Here, in a case where there is a deviating setting value in security policy items to be imported, the security policy setting application 253 overwrites a target item on the RAM 214 with an undeviating closest value.

With the processing operations performed up to this point, items of security policies to be imported become values which are able to be retained in the image processing apparatus 200, and the values are passed from the security policy setting application 253 to the setting value storing module 262 and are thus stored in the NVRAM 215. However, at this point, the imported security policies may not yet be reflected in the setting items of the image processing apparatus 200, which are thus in an incomplete and inconsistent state. Next, to perform processing for correcting this state, the setting value import application 256a advances the processing to step S1116.

In step S1116, the setting value import application 256a refers to setting types to be imported passed from the web UI control module 251, and thus determines whether any one of a setting item and a security policy is included in the setting types to be imported. If it is determined that none of them is included (NO in step S1116), i.e., in a case where import of only address books is performed, the setting value import application 256a advances the processing to step S1118, which is determination of import of address books.

On the other hand, if it is determined that any one of them is included (YES in step S1116), the setting value import application 256a advances the processing to step S1117.

In step S1117, the setting value import application 256a performs processing for applying a security policy. In the processing for applying a security policy, the setting value import application 256a invokes a module which reflects a security policy which the security policy setting application 253 provides in a setting item. Then, the module performs storing of a value of the currently enabled security policy item, which the security policy setting application 253 is managing, in the NVRAM 215 via the setting value storing module 262. Thus, the value of a setting item which depends on the currently enabled security policy in the imported values is then overwritten with the thus-stored value.

Furthermore, a setting item which depends on a predetermined security policy item has been described above with reference to FIG. 7.

Furthermore, the processing operation in step S1117 is processing which has to be necessarily performed in a case where any one of import processing in step S1113 and import processing in step S1115 has been performed. The processing operation in step S1117 performs forced overwriting without performing, for example, comparative determination or conditional determination between the value of a setting item and the value compatible with a security policy, thus enabling preventing or reducing an increase in processing load in the image processing apparatus 200 and applying a security policy in a short time.

Next, in step S1118, the setting value import application 256a refers to types of setting values to be imported passed from the web UI control module 251, and determines whether an address book is included in the types of setting values to be imported.

Here, if it is determined that an address book is included in the types of setting values to be imported (YES in step S1118), the setting value import application 256a advances the processing to step S1119.

On the other hand, if it is determined that no address book is included in the types of setting values to be imported (NO in step S1118), the setting value import application 256a advances the processing to step S1120.

In step S1119, the setting value import application 256a performs import processing for address books. In the import processing for address books, the setting value import application 256a confirms a security policy for which application processing has been performed immediately before step S1119 and determines whether to perform import. Specifically, in a case where the setting value of the security policy setting “Permit transmission only to a destination previously registered with an address book” indicated by the item ID 10012 illustrated in FIG. 7 is “ON”, i.e., is enabled, the following setting values are affected. Since, first, the item ID 02001 “Permit addition of a new address” is restricted to “OFF” and, secondly, changing of pieces of address book information written in rows of the item ID 02002 and subsequent item IDs is prohibited, import of address books is substantially restricted. In a case where import of address books has been restricted by a security policy, the setting value import application 256a ends import processing for address books without importing address books. On the other hand, in a case where import of address books is not restricted by a security policy, the setting value import application 256a performs import of address books. In the import of address books, the setting value import application 256a identifies <AddressBook>, which is a tag in a middle item of the decrypted XML, by XML analytical processing, and sets the setting values one by one to arrays allocated as retention regions for address books on the RAM 214. In each address book, a number of data blocks each having a structure for storing, unlike other setting values, not accompanying information but pieces of stylized constituent information such as the full name of a registrant, the name of an organization, and a telephone number or e-mail address are allocated and interconnected, thus being loaded on a memory. The constructed address book data blocks are passed to a module for import which the address book setting application 255 provides, so that a new address book imported after initialization of the existing address book is then stored in the NVRAM 215 via the setting value storing module 262.

After the import processing for address books is complete, the setting value import application 256a advances the processing to step S1120. In step S1120, the setting value import application 256a determines whether to perform restart of the image processing apparatus 200. This determination is performed, as with determination in step S1116, to determine whether any one of a setting item and a security policy is included in the setting types to be imported. If it is determined that none of them is included (NO in step S1120), i.e., in a case where import of only address books is performed, the setting value import application 256a advances the processing to step S1121 without restarting the image processing apparatus 200.

In step S1121, the setting value import application 256a notifies the web UI control module 251 that the import processing has been completed. In response to this notification, the web UI control module 251 generates an import completion screen 1050, and transmits, as a response, the import completion screen 1050 to the terminal device 300 via the web server module 244.

FIG. 13E illustrates an example of the import completion screen 1050, which the image processing apparatus 200 has transmitted as a response. In response to an OK button 1051 being pressed, the import processing ends, so that the processing illustrated in the flowcharts of FIGS. 14A and 14B ends.

On the other hand, if it is determined that any one of a setting item and a security policy is included (YES in step S1120), the setting value import application 256a advances the processing to step S1122.

In step S1122, the setting value import application 256a issues an event for requesting restart to the system control module 261, thus restarting the image processing apparatus 200.

FIG. 13D illustrates an example of the screen 1040, which the web browser of the terminal device 300 displays upon receiving response data indicating that the image processing apparatus 200 is being restarted in response to the completion of import, which the image processing apparatus 200 has transmitted as a response. In the screen 1040, the web browser operates in such a way as not to receive an operation performed by the user. Then, the web browser periodically inquires whether restart of the image processing apparatus 200 has been completed, in the background processing for the web browser, and, in a case where the restart has been completed, displays a top screen for the web UI of the image processing apparatus 200, so that the import processing is complete.

Furthermore, while, in the above description, the setting types to be exported or imported are a setting item, a security policy, and an address book, user account data can also be included in the setting types to be exported or imported. Import processing for user account data is similar to the import processing for address books. Specifically, the setting value import application 256a refers to the types of setting values to be imported passed from the web UI control module 251, and determines whether user account data is included in the types of setting values to be imported. Here, if it is determined that user account data is included, the setting value import application 256a performs import processing for user account data. In the import processing for user account data, the setting value import application 256a checks a security policy for which application processing has been performed immediately before that time and thus determines whether to perform import. Specifically, in a case where a specific security policy setting (a security policy setting for restricting setting of user accounts) is included in the security policy settings, the setting value import application 256a does not import user account data and ends the import processing for user account data. On the other hand, in a case where the specific security policy setting is not included in the security policy settings, the setting value import application 256a performs control to import user account data.

As described above, after processing for overwriting a setting item (or setting values of a security policy) with the imported values is performed, the setting item is further overwritten with the setting values of the security policy. Furthermore, with regard to an address book, in a case where, when a security policy is checked, import of address books is restricted by the security policy, import of address books is not performed. This enables maintaining restriction of setting values by the security policy setting in the setting value import processing. Additionally, compared with a conventional configuration in which, with regard to all of the setting items included in an apparatus, it is checked whether each setting item is restricted by the security policy setting, the number of times for which comparison and checking are performed is smaller, so that it is possible to prevent or reduce an increase in processing load due to the number of setting items and also to shorten the user's waiting time. Thus, as compared with the conventional configuration, it is possible to, while preventing or reducing an increase in processing load due to the number of setting items, import setting values in a short time in such a manner that the restriction by a security policy is maintained and to dramatically improve usability. For example, even in a case where all of the device settings are exported for, for example, repair and, after the completion of repair, all of the device settings are imported, as compared with the conventional configuration, processing is complete in a short time, so that, as compared with the conventional configuration, it is possible to greatly reduce a burden on an administrator who takes charge of, for example, maintenance management of the apparatus.

Furthermore, the configurations of various pieces of data and contents thereof described above are not limited to those, and, naturally, various configurations and contents thereof can be employed according to use applications and purposes.

While aspects of the present exemplary embodiment have been described, the present disclosure can be embodied as, for example, a system, an apparatus, a method, and a program or storage medium. Specifically, the present disclosure can be applied to a system composed of a plurality of pieces of equipment, or can be applied to an apparatus composed of one piece of equipment.

Moreover, a configurations obtained by combining some or all of the above-described aspects of the present exemplary embodiment is also included in the present disclosure.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-023236 filed Feb. 19, 2024, which is hereby incorporated by reference herein in its entirety.

What is claimed is:

1. An information processing apparatus comprising:
a non-volatile memory;
a first management unit configured to manage a security policy setting;
a second management unit configured to manage setting values of a setting item group which affects at least one or more operations of the information processing apparatus;
one or more memories storing instructions; and
one or more processors capable of executing the instructions causing the information processing apparatus to:
retain, in the non-volatile memory, an operation setting of the information processing apparatus;
receive a setting value group serving as a target for import; and
perform control in such a manner that first processing for storing at least a part of the received setting value group as the operation setting which is retained in the non-volatile memory and second processing for, after the first processing, storing, by overwrite, setting values which the second management unit manages in such a way as to satisfy the security policy setting which the first management unit manages, as a part of the operation setting which is retained in the non-volatile memory are performed as a series of processing operations in import processing.

2. The information processing apparatus according to claim 1, wherein, in a case where the security policy setting is included in the received setting value group, in the first processing, the received security policy setting is stored as the operation setting in the non-volatile memory.

3. The information processing apparatus according to claim 2, further comprising a third management unit configured to manage address setting data constituting an address book, which is not included in setting items which the second management unit manages,
wherein, in a case where the address setting data is included in the received setting value group, after the first processing in the series of processing operations in import processing, according to a specific security policy being set to the security policy setting which the first management unit manages, the second processing is performed without the received address setting data being stored as the operation setting in the non-volatile memory.

4. The information processing apparatus according to claim 3, wherein, in a case where the address setting data is included in the received setting value group, after the first processing in the series of processing operations in import processing, according to the specific security policy being not set to the security policy setting which the first management unit manages, the second processing is performed with the received address setting data having been stored as the operation setting in the non-volatile memory.

5. The information processing apparatus according to claim 2, further comprising a fourth management unit configured to manage user account data, which is not included in setting items which the second management unit manages,
wherein, in a case where the user account data is included in the received setting value group, after the first processing in the series of processing operations in import processing, according to a specific security policy being set to the security policy setting which the first management unit manages, the second processing is performed without the received user account data being stored as the operation setting in the non-volatile memory.

6. The information processing apparatus according to claim 5, wherein, in a case where the user account data is included in the received setting value group, after the first processing in the series of processing operations in import processing, according to the specific security policy being not set to the security policy setting which the first management unit manages, the second processing is performed with the received user account data having been stored as the operation setting in the non-volatile memory.

7. A control method for an information processing apparatus including a non-volatile memory, a first management unit configured to manage a security policy setting, and a second management unit configured to manage setting values of a setting item group which affects at least one or more operations of the information processing apparatus, the control method comprising:
retaining, in the non-volatile memory, an operation setting of the information processing apparatus;
receiving a setting value group serving as a target for import; and
performing control in such a manner that first processing for storing at least a part of the received setting value group as the operation setting which is retained in the non-volatile memory and second processing for, after the first processing, storing, by overwrite, setting values which the second management unit manages in such a way as to satisfy the security policy setting which the first management unit manages, as a part of the operation setting which is retained in the non-volatile memory are performed as a series of processing operations in import processing.
